(19) United States
(12) Patent Application Publication
(10) Pub. No.: US 2018/0251123 A1
(43) Pub. Date: Sep. 6, 2018

(54) Active Series Hybrid Integrated Electric Vehicle

(71) Applicant: Axel Michael Sigmar, Lago Vista, TX (US)

(72) Inventor: Axel Michael Sigmar, Lago Vista, TX (US)

(21) Appl. No.: 15/859,496

(22) Filed: Dec. 30, 2017

Related U.S. Application Data
(60) Provisional application No. 62/440,984, filed on Dec. 30, 2016.

(51) Int. Cl. B60W 30/045; B60K 7/00; B60K 17/34; B60W 10/08; B60W 10/22; B60W 20/00

(52) U.S. Cl. CPC B60W 30/045; B60K 7/0007; B60K 17/358; Y10S 903/93; B60W 10/22; B60W 20/00; B60K 2007/0092; B60W 10/08

(57) ABSTRACT

In some embodiments, a system can include an integrated wheel module coupled to a rim of a tire and to a structure of a vehicle. The integrated wheel module can include control electronics and a power supply. The integrated wheel module may further include a plurality of electric motors, including a first motor responsive to the control electronics and configured to rotate the tire about an axis; a second motor responsive to the control electronics and configured to turn the tire about a pivot point; a third motor responsive to the control electronics and configured to continuously and dynamically adjust a camber of the tire; a fourth motor responsive to the control electronics and configured to continuously and dynamically adjust a suspension associated with the tire; and a fifth motor configured to adjust the suspension spring in accordance with the load, conditions and optimum performance desired.

### CROSS-REFERENCE TO RELATED APPLICATION(S)

This application is a non-provisional of and claims priority to U.S. Provisional Patent Application No. 62/440,984 filed on Dec. 30, 2016 and entitled “Active Series Hybrid Integrated Electric Vehicle”, which is incorporated herein by reference in its entirety.

### FIELD

The present disclosure is generally related to integrated electrical vehicle systems and methods, and more particularly to modular, scalable integrated vehicle systems and methods.

### BACKGROUND

Industrial vehicles and passenger vehicles typically include an engine, a transmission coupling the engine to driving wheels, and a pair of steerable wheels. The steerable wheels may be controlled by a steering wheel or other steering device provided adjacent to a driver's seat. In many cars and trucks, the steering mechanisms may be aided by power steering mechanisms to assist the driver in turning the wheels.

### SUMMARY

In some embodiments, a system can include an integrated wheel module coupled to a rim of a tire and to a structure of a vehicle. The integrated wheel module can include control electronics and a power supply. The integrated wheel module may further include a plurality of electric motors, including a first motor responsive to the control electronics and configured to rotate the tire about an axis; a second motor responsive to the control electronics and configured to turn the tire about a pivot point; a third motor responsive to the control electronics and configured to continuously and dynamically adjust a camber of the tire; a fourth motor responsive to the control electronics and configured to continuously and dynamically adjust a suspension associated with the tire; and a fifth motor configured to adjust the suspension spring in accordance with the load, conditions and optimum performance desired.

In some embodiments, an active series hybrid integrated electric vehicle is disclosed. The vehicle may include a plurality of integrated wheel modules, each of which may include a motor to rotate the wheel about an axis, a drive assembly (such as a worm drive or a direct drive gear assembly) configured to turn the wheel about a pivot axis, and a second drive assembly configured to selectively adjust a camber of the wheel. In some embodiments, each integrated wheel module may also include a driven active suspension including a coil and a linear dampening motor configured to adjust the coil. Further, in some embodiments, each integrated wheel module may include a plurality of super capacitors, batteries or energy storage devices internal to the wheel and configured to switch or store power.

In some embodiments, each integrated wheel module may include a driven regenerative braking wheel that is steerable on an independent active suspension and with active camber. Each integrated wheel module may also include a super capacitor, which may be configured capture, switch and store charge derived, for example, from regenerative braking. The plurality of wheel modules may be controlled by electrical signals and may provide differential-less stability control for a vehicle, incorporating rapid bi-directional (acceleration and deceleration) control of rotation of each wheel, steering of each wheel, and optimization of the tire contact patch of each wheel via active camber, all in conjunction with the other wheels and suspension to achieve active control of the vehicle attitude, particularly but not limited to, roll and yaw.

In some embodiments, a system may include a controller configured to control a plurality of independent wheel modules. The system may control each wheel module to turn independently. Further, the system may control each wheel module to tilt (active camber). In some embodiments, the system may control each wheel module to adjust the suspension (active suspension). The system can also control an active suspension for the driver's cabin, the passenger's cabin, the cargo cabin, or any combination thereof. In some embodiments, the system may also use regenerative braking to restore some electric charge to the batteries (as well as charging at least one battery or capacitor within the wheel module). The system may also utilize intelligent route planning and other features to optimize power consumption and to provide alerts to a driver regarding when to recharge.

In some embodiments, a system can include an integrated wheel module coupled to a rim of a tire and to a structure of a vehicle. The integrated wheel module can include control electronics and a power supply. The integrated wheel module may further include a plurality of electric motors, including a first motor responsive to the control electronics and configured to rotate the tire; a second motor responsive to the control electronics and configured to turn the tire; a third motor responsive to the control electronics and configured to adjust a camber of the tire; a fourth motor responsive to the control electronics and configured to adjust a suspension associated with the tire; and a fifth motor to adjust the coil in accordance with the load being carried by the vehicle.

### BRIEF DESCRIPTION OF THE DRAWINGS

FIG. 1 depicts a block diagram of a vehicular system, in accordance with certain embodiments of the present disclosure.

FIG. 2 depicts a long-haul truck in an exploded view showing conventional component assemblies that can be removed and illustrating some components of an integrated electrical vehicle system that can replace the removed conventional component assemblies, in accordance with certain embodiments of the present disclosure.

FIG. 3 depicts a garbage truck including integrated electrical vehicle systems, in accordance with certain embodiments of the present disclosure, wherein the payload actuators may be electric and integrated into the overall vehicle concept, dynamic control system and user interface.

FIG. 4A depicts an exploded view of components of an integrated wheel assembly, in accordance with certain embodiments of the present disclosure.

FIG. 4B depicts a cross-sectional view of a portion of a vehicle including a pair of integrated wheel assemblies, in accordance with certain embodiments of the present disclosure.

FIG. 5A depicts a side view of an integrated wheel assembly, in accordance with certain embodiments of the present disclosure.

FIG. 5B depicts a cross-sectional exploded view of the integrated wheel assembly taken along line B-B in FIG. 5A, in accordance with certain embodiments of the present disclosure.

FIG. 6A depicts a circumferential radial power array of the wheel assembly, in accordance with certain embodiments of the present disclosure.

FIG. 6B illustrates a cross-sectional view of the circumferential radial power array taken along line B-B in FIG. 6A.

FIG. 7 depicts an exploded view of the electric motor of FIG. 1, in accordance with certain embodiments of the present disclosure. 0008

FIG. 8 depicts a perspective view of the stator of the motor of FIGS. 1-4, in accordance with certain embodiments of the present disclosure.0008

FIG. 9 illustrates a cross-sectional view of the integrated wheel module of FIG. 2, in accordance with certain embodiments of the present disclosure.

FIG. 10 depicts a vehicle system including a frame and including two wheel assemblies adapted to turn, in accordance with certain embodiments of the present disclosure.

FIG. 11 depicts a vehicle system including a frame and including multiple wheel assemblies adapted to turn, in accordance with certain embodiments of the present disclosure.

FIG. 12 depicts an exploded perspective view of structural components configured to provide a dynamic camber adjustment, in accordance with certain embodiments of the present disclosure.

FIG. 13 depicts a front perspective view of a portion of a vehicle including wheel modules configured to provide dynamic camber adjustments independently, in accordance with certain embodiments of the present disclosure.

FIG. 14 depicts a perspective view of an apparatus including coil having adjustable compression, in accordance with certain embodiments of the present disclosure.

FIGS. 15A-15C depict views of a linear actuator portion of the apparatus of FIG. 14, in accordance with certain embodiments of the present disclosure.

FIG. 15D depicts a perspective view of a drive element portion of the apparatus of FIG. 14, in accordance with certain embodiments of the present disclosure.

FIGS. 16A and 16B depict views of the drive element portion of the apparatus of FIGS. 14 and 15D, in accordance with certain embodiments of the present disclosure.

FIG. 17A depicts a side view of the apparatus of FIG. 14, in accordance with certain embodiments of the present disclosure.

FIG. 17B depicts a side cross-sectional view of the apparatus of FIG. 17A.

In the following discussion, the same reference numbers are used in the various embodiments to indicate the same or similar elements.

### DETAILED DESCRIPTION OF ILLUSTRATIVE EMBODIMENTS

In the following detailed description of embodiments, reference is made to the accompanying drawings which form a part hereof, and which are shown by way of illustrations. It is to be understood that features of various described embodiments may be combined, other embodiments may be utilized, and structural changes may be made without departing from the scope of the present disclosure. It is also to be understood that features of the various embodiments and examples herein can be combined, exchanged, or removed without departing from the scope of the present disclosure.

In accordance with various embodiments, some of the methods and functions described herein may be implemented as one or more software programs running on a computer processor or controller, which may be configured to interact with various devices, for example to control their operations. In certain embodiments, such a processor or controller may be a component of a computing device, such as a tablet computer, a smartphone, a personal computer, a server, a dedicated integrated computing device, or any combination thereof. Dedicated hardware implementations including, but not limited to, application specific integrated circuits, programmable logic arrays, and other hardware devices can likewise be constructed to implement the methods and functions described herein. A layered hierarchical architecture of computational, control and communication devices may be included proximate to the assemblies that they sense and control, both individually and in combination, to achieve the combinatorial behavior desired on varying dynamic timeframes. Further, at least some of the methods described herein may be implemented as a device, such as a computer readable storage device or memory device, including instructions that when executed cause a processor to perform the methods.

### A. Overview

Embodiments of electrical vehicle systems, control systems, devices, apparatuses, and methods are described below that may be utilized to construct an integrated electrical vehicle. In certain embodiments, the system may include a plurality of wheel modules. Each wheel module may include a coupling assembly configured to couple the wheel module to a frame of a vehicle. Each wheel module may include an electric motor configured to deliver torque directly to the rim of the tire without the need for an axle, a transmission or a transaxle. Each wheel module may be configured to be independently steerable, and may be configured to provide an independent active suspension as well as independent active camber adjustments. Further, each wheel-based electrical module may be configured to provide regenerative braking. A control system may be configured to communicate with each of the wheel modules independently and may coordinate operation of the wheel modules to facilitate various operations of the wheels, including acceleration, breaking, steering, camber angles, tilt, load balancing, other operations, or any combination thereof.

The wheel modules enable modular design of vehicular systems. Each wheel module may provide a pre-determined amount of instantaneous and continuous horse power to the vehicular system, such that the amount of power needed for a particular implementation may determine the number of wheel modules to be used. Further, the independently steerable wheel modules enable electronic steering control, enabling a variety of control features that may be used to maximize the total directional thrust achievable by each wheel and the vehicle as a whole to improve the vehicle dynamics, safe operation, driver's experience and to enhance overall efficiency of the system.

### B. The System

A system is described below that may include hardware components, such as integrated wheel modules, support frames, power systems, input elements (e.g., steering wheels, speed control components, manual braking components, rechargeable batteries, active cab suspension components, other components, or any combination thereof. Further, the system may include software components, including control software accessible through input elements (such as a dashboard display or console) to control operation of the hardware components, and including automatic control software configured to monitor various sensors, including linear and angular acceleration sensors, tilt sensors, load sensors, temperature sensors, vibration sensors, and other sensor inputs and to automatically and selectively adjust a parameter associated with one or more of the hardware components in response to the sensor inputs, command inputs and the influence of external forces and perturbations.

In general, a wheel module is described below that may include an integrated electric motor, integrated steering, integrated active camber, and an integrated adjustable active suspension. The wheel module may be a building block of an electric vehicle, such as a car, a pickup truck, a recreational vehicle (RV), a trash collection truck, a dump truck, a long haul truck, or any other type of vehicle or transportation unit.

It should be appreciated that integration of the various components in the wheel module provides a large number of advantages. First, the active suspension and dynamic camber adjustments can be controlled by the control system and/or by power electronics within each wheel module to provide continuous and dynamic adjustments during operation to account for various conditions, including shifting loads, shifting center of gravity, road conditions, steering actions, and so on. In the context of a long-haul truck implementation, cross-winds can cause the road contact patch of the tires to vary, can cause the load to sway, and can create a dynamically varying load condition. The active suspension can raise the wheel modules on a windward side and/or lower the wheel modules on the leeward side to tilt the vehicle load slightly into the wind. At the same time, the active camber adjustment can be adjust the camber angles of each of the integrated wheel modules independent from one another in order to enhance the road contact patch of each wheel. The combination may reduce the loading effect of the wind and improve handling and safety.

In the context of cornering, the suspension can be dynamically and continuously raised or lowered and the camber angles of each wheel module can be adjusted continuously to enhance handling and performance during turning operations and during straight line acceleration (or braking). In the context of road hazards or bumps, when the first wheel module encounters a bump, the control system may notify the other wheel modules, such that the active suspension of a next wheel module in the direction of travel may being to raise the wheel above the bump. The work performed in raising the tire partially dampens the vibration from the first wheel module striking the bump. Moreover, the next wheel module at least partially avoids the bump and so on. Avoiding such bumps can improve handling and performance, can reduce wear on the vehicle components, and improve overall safety of the system.

In the context of a low tire pressure event, the active suspension may be configured to raise a wheel module above the road surface for servicing and/or to continue to travel. In the latter case, the system may utilize the active suspensions of each of the wheel modules to distribute the loading, allowing the vehicle to continue on its route without having to stop to service the tire and without endangering other drivers on the road.

In general, the vehicle attitude can be managed for detected conditions like turns, tilt of the road surface, yaw and pitch of the vehicle, and anticipated based on signals from yaw rate sensors compared to the steering input or from vibrations or actions detected from other wheel modules. Thus, the vehicle may be configured to utilize the wheel modules to enhance safety and performance while reducing conditions that might promote wear on the vehicle. Other advantages provided by integration of the various functions with the motor and the electronics will also become clear to workers skilled in the art in light of the discussion below.

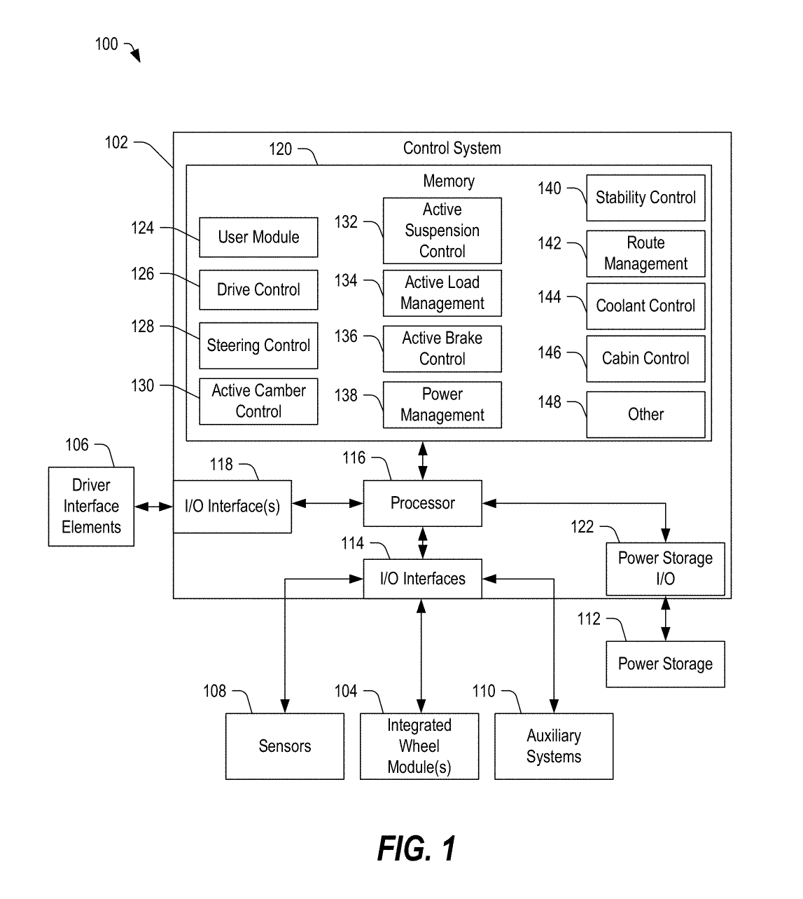

The system may include a plurality of wheel modules, a plurality of sensors, a plurality of user-accessible input elements, a plurality of batteries, and a control system. The control system may be coupled to each of the other elements through electrical wiring. In some embodiments, the control system may receive data from each of the plurality of wheel modules, the plurality of sensors, the plurality of user-accessible input elements, and a power system associated with the plurality of batteries. One possible example of a system including a control system incorporating a combination of active and passive feed-back and feed-forward state and load dependent filters, and various components is described below with respect to FIG. 1.

FIG. 1 depicts a block diagram of a system 100 including a control system for an integrated electric vehicle, in accordance with certain embodiments of the present disclosure. The system 100 may include a control system 102 configured to communicate with one or more integrated wheel modules 104. Further, the control system 102 may communicate with one or more driver interface elements 106, such as a steering wheel or joystick, a brake pedal, an acceleration pedal (“gas pedal”), a touchscreen interface element, switches, toggles, sliders, knobs, other control elements, or any combination thereof. The control system 102 may also communicate with one or more sensors 108, such as temperature sensors, pressure sensors, power sensors, slip sensors, tilt sensors, accelerometers, gyroscopes, inclinometers, yaw sensors, other sensors, or any combination thereof. Additionally, the control system 102 may communicate with auxiliary systems 110, such as lighting systems, stability control systems, active cabin suspension systems, heating systems, air conditioning systems, other systems, or any combination thereof. Further, the control system may also communicate with a plurality of power storage and generation systems 112.

The control system 102 may include one or more input/output (I/O) interface 114, which may be coupled to the integrated wheel modules 104, the sensors 108, and the auxiliary systems 110. Further, the control system 102 may include one or more I/O interfaces 118 configured to communicate with driver interface elements 106. Further, the control system 102 may include a power storage I/O interface 122 coupled to the power storage systems 112. The control system 102 may include a processor 116 coupled to the I/O interfaces 114, 118, and 122, and coupled to a memory 120.

The memory 120 may store data and a plurality of instructions that, when executed, cause the processor 116 to receive input signals from the driver interface elements 106 and to selectively control one or more of the integrated wheel modules 104 and the auxiliary systems 110 in response to the signals. Further, in some embodiments, the memory 120 may store instructions that, when executed, may cause the processor 116 to automatically control one or more of the integrated wheel modules 104, the sensors 108, and the auxiliary systems 110. In an example, the processor 116 may automatically adjust a camber of selected ones of the integrated wheel modules 104, adjust a linear motor associated with an adjustable coil of one or more of the integrated wheel modules 104, adjust power delivered to a motor of one or more of the integrated wheel modules 104, and so on. In another example, the processor 116 may interact with one or more of the integrated wheel modules 104 to calibrate a load distribution of the system 100 and may selectively and independently adjust one or more parameters of one or more of the integrated wheel modules based on the calibration. Other automatic adjustments may also be made, depending on the implementation.

The memory 120 may include a user module 124 that, when executed, may cause the processor 116 to receive input data from the driver interface elements 106. In some embodiments, the user module 124 may cause the processor 116 to interact with one or more of the driver interface elements 106 to provide haptic feedback. Further, in some instances, user module 124 may cause the processor 116 to present a graphical interface to a computing device associated with the driver interface elements 106. Other embodiments are also possible.

The memory 120 may include drive control instructions 126 that, when executed, may cause the processor 116 to receive input from one or more of the driver interface elements 106 and to selectively control one or more of the integrated wheel modules 104 to rotate, accelerate, or decelerate. In some embodiments, the drive control instructions 126 may cause the processor 116 to manage the rotational velocity of each wheel via the integrated wheel modules 104. In some embodiments, the processor 116 may control a rotational velocity, acceleration or jerk of each wheel independently of the other wheels. In some embodiments, the drive control instructions 126 may cause the processor 116 to communicate with circuitry within the integrated wheel modules 104 and optionally to bypass one or more stator coils, for example, to reduce power consumption, such as when the vehicle is on a downhill slope or when the vehicle is traveling at a constant velocity along a relatively flat surface. Other embodiments are also possible.

The memory 120 can include steering control instructions 128 that, when executed, may cause the processor 116 to selectively pivot one or more of the integrated wheel modules 104 relative to a frame to which the integrated wheel modules 104 are attached. In some embodiments, the processor 116 may control a worm drive within the integrated wheel module 104 to pivot the integrated wheel module 104 about an axis. Each integrated wheel module 104 may be pivoted independently of the other wheel modules 104, making it possible to adjust each wheel according to the desired turn radius.

The memory 120 may further include active camber control instructions 130 that, when executed, may cause the processor 116 to control a worm or other drive within one or more of the integrated wheel modules 104 to adjust a tilt or camber of the wheel relative to the frame and to the road surface. Each wheel may be adjusted independently of the other wheels, making it possible to selectively adjust the camber of each of the integrated wheel modules 104.

The memory 120 may also include active suspension control instructions 132 that, when executed, may cause the processor 116 to control a linear motor of a coil assembly to selectively adjust a spring rate and dampening effect of the coils. In some examples, the linear motor of the coil assembly may be used to dynamically compress the coil in a positive or negative direction. Further, in some examples, the linear motor of the coil assembly may dynamically adjust a load on a coil by adjusting a linear motor relative to the coil to enhance the operation of the shock absorption, to balance a load, to assist in off-setting centrifugal forces during a turn, for other reasons, or any combination thereof. In certain embodiments, by adjusting the linear motor, the integrated wheel module 104 may be raised or lowered relative to the substrate to which it is attached.

The memory 120 may further include an active load management module 134 that, when executed, may cause the processor 116 to calibrate a load balance, such as by selectively raising and lowering selected ones of the plurality of integrated wheel modules 104 to determine a configuration of the load, such as when materials are loaded into a short or long-haul truck. In this example, the active load management 134 may determine one or more adjustments for the active suspension control module 132 to adjust the suspension to compensate for the load distribution. In another example, the load management module 134 may cause the processor 116 to determine a change in the load balance based on data determined from the one or more sensors and may cause the active suspension control 132 to adjust the suspension to compensate for the change. In some embodiments, the load management module 134 or another module may cause the processor 116 to adjust the spring rates of a linear motor of an active suspension up or down to compress or to decompress a spring of an active suspension coil. In an example, the adjustable coil and the corresponding motor adjustment may be controlled to dynamically adjust the ride height as well as keep the adjustable coil in a neutral (electronically) position relative to the tilt and load of the vehicle. For example, if the weight of the load in combination with road conditions creates a condition where the spring is bottoming out or the suspension is in a less than efficient position, the height may be dynamically controlled to improve the ride and resulting vehicle dynamics of the vehicle through its active and passive suspension. In a particular example, the suspension may be controlled to generate a neutral (equal pressure on all tires) load scenario as well as to even out the driving experience, which can enhance safety. Other embodiments are also possible.

The memory 120 may also include an active brake control module 136 that, when executed, may cause the processor 116 to provide control signals to one or more braking components of the integrated wheel modules 104. In some embodiments, the active break control module 136 may also cause the processor 116 to send control signals to one or more auxiliary systems, such as an emergency braking system, brake lights, other circuits or devices, or any combination thereof. Further, in some embodiments, the active brake control module 136 may cause the processor 116 to control one or more modules within a selected integrated wheel module 104 to recapture energy during the braking process (i.e., regenerative braking).

The memory 120 may further include a power management module 138 that, when executed, may cause the processor 116 to communicate with the power storage systems 112 and to provide dynamic load balancing, both in terms of power usage and recharge. The memory 120 may also include stability control 140 that, when executed, may cause the processor 116 to manage power allocated to each integrated wheel module 104 to control slippage between a tire and a surface. Further, the stability control 140 may cause the processor 116 to communicate with the active suspension control 132, active break control 136, and active camber control 130 to enhance stability of the system 100, such as by adjusting the camber as the vehicle enters or leaves a turn, for example.

The memory 120 may also include a route management module 142 that, when executed, may cause the processor 116 to predict and to learn system parameters over time. For example, the system 100 may utilize an average amount of power each time a particular route is traversed by the system 100. In such an example, the route management module 142 may cause the processor 110 to activate backup systems or otherwise recharge the batteries to ensure that the system 100 has sufficient power to complete the route. Other examples are also possible.

The memory 120 may also include coolant control instructions 144 that, when executed, may cause the processor 116 to provide control signals to an auxiliary system 110, such as a coolant circulation pump, to deliver coolant to a particular device or module (such as a particular integrated wheel module 104). In some embodiments, the memory 120 may also include a cabin control module 146 that, when executed, may cause the processor 116 to control an active suspension associated with the cabin.

In certain embodiments, the memory 120 may include other instructions 148 that, when executed, may cause the processor 116 to perform a variety of operations. In an example, one or more auxiliary systems 110 may include an electronic lift or actuator, and the other instructions 148 may cause the processor 116 to send control signals to control operation of the electronic lift or actuator. Other embodiments are also possible.

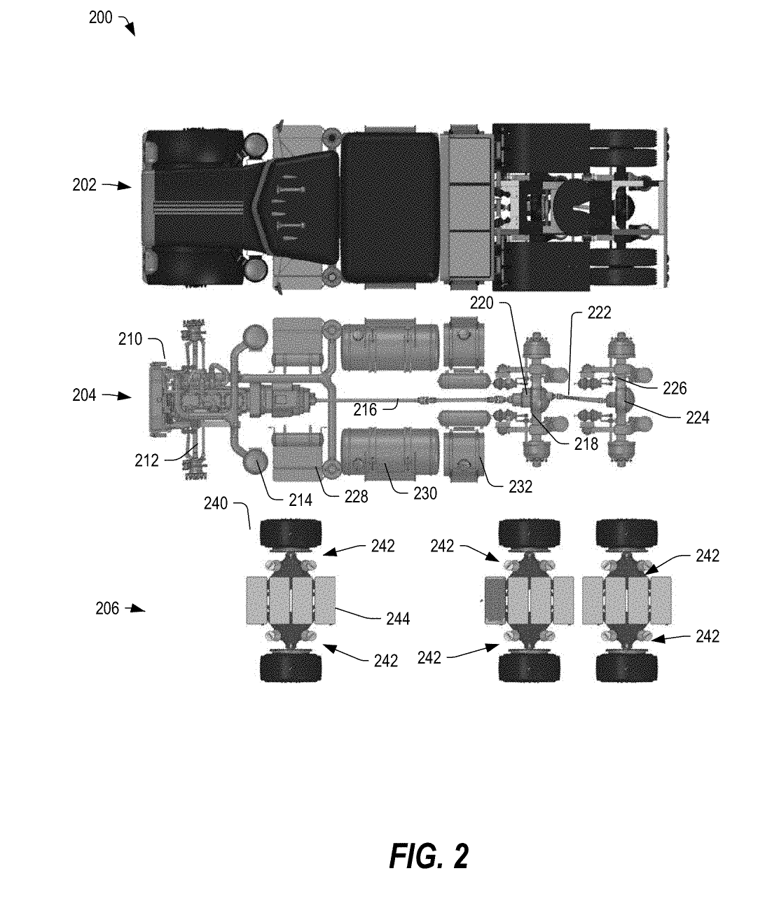

In certain embodiments, the integrated wheel modules 104 enable integrated management and control of a plurality of operations of a vehicle through electronic signals. As discussed below with respect to FIG. 2, the integrated wheel modules make it possible to simplify the vehicle components. More importantly, the integrated wheel modules render a large number of components obsolete, making it possible to remove them, reducing the overall weight of the vehicle and increasing the usable area of the frame. Moreover, the integrated wheel modules provide functionality that is not otherwise available, such as fully independent steering; differential-less stability control; transmission-less power delivery to each wheel, independently; independent active suspension with active camber adjustment; independent braking; dynamic load adjustment; and various other advantages and features. In some embodiments, the integrated wheel module may include dynamic vehicle yaw management, such that when a vehicle corners and the system is detecting slip in the front (for example), the system can control each wheel independently to adjust the vehicle's rear to compensate for oversteer or understeer conditions.

FIG. 2 depicts a long-haul truck 200 in an exploded view showing conventional components that can be removed and illustrating some components of an integrated electrical vehicle system that can replace the removed conventional components, in accordance with certain embodiments of the present disclosure. In the illustrated example, a conventional truck 202 is shown.

At 204, elements of the conventional truck 202 that can now be omitted are shown. These omitted elements may include three axles 212, 218 and 226, an engine 210, exhaust pipes 214, fuel tanks 228 and 230, pneumatic braking systems 232, a drive train 216 and 222, and transmissions 220 and 222. Further, the omitted elements can also include auxiliary transmissions and power take-off systems, as well as auxiliary air, hydraulics, and power for trailer systems, and so on.

The elements generally indicated at 206 replace the omitted elements 204. In particular, the included elements include the tires 240, which may be the same as the (wide-base) tires used with the conventional truck 202. The elements may further include a plurality of integrated electric wheel modules 242 and a plurality of batteries 244. The wheel modules 242 may be coupled directly to the frame of the truck 202, without the need for axles, transmissions, or other components of a conventional system. Further, each wheel module 242 may include a capacitor bank, super capacitor, battery assembly, other energy storage element, and power switching electronics, or any combination thereof.

In the illustrated example, the wheel modules 242 may include integrated active steering, dynamic active suspension, and active camber elements that facilitate a large number of advantages over conventional systems. Moreover, when a component of the wheel module 242 fails, the entire wheel module 242 may be replaced in a manner of minutes by elevating the other wheel modules 242 using the active suspension, removing the failed module, and coupling the replacement module. The electrical interconnection may be a simple plugin-type connector configured to facilitate the electrical interconnection. In some embodiments, the vehicle may include multiple integrated wheel modules 242, each of which may be identical in terms of the functionality, and thus the integrated wheel module 242 can replace all modules front back left and right. The symmetry of the unit allows for complete integration at all positions.

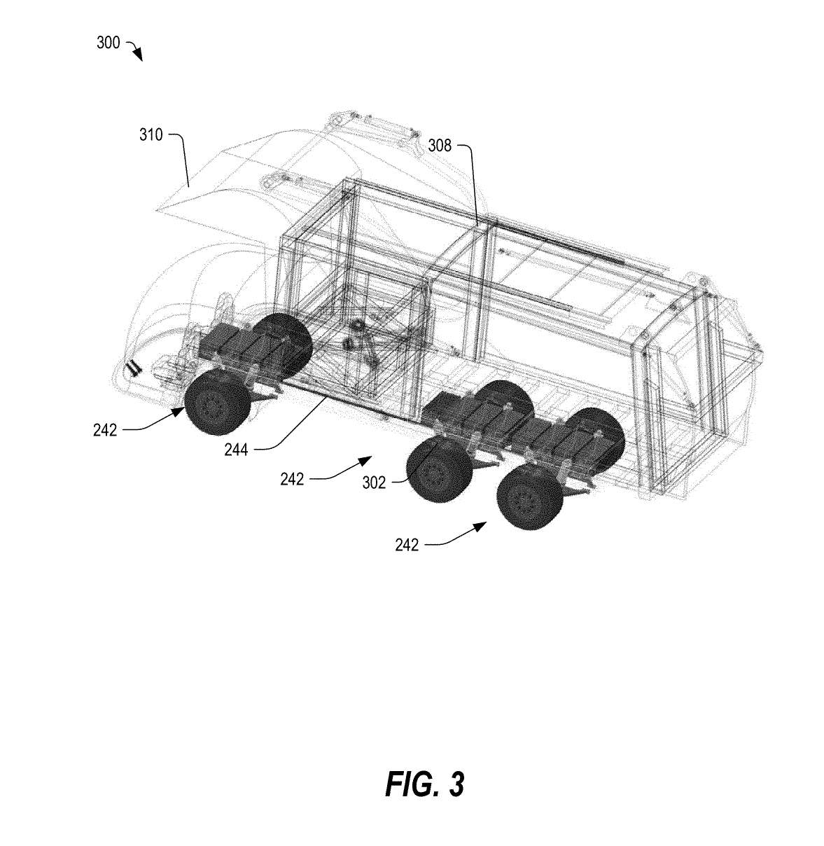

FIG. 3 depicts a garbage truck 300 including integrated electrical vehicle systems, in accordance with certain embodiments of the present disclosure. The garbage truck 300 may include a plurality of wheel modules 242, each of which may be coupled to a frame 302 of the vehicle. The batteries 244 may be mounted on the frame 302.

In the illustrated example, the garbage truck 300 may include a housing 308 and a lift assembly 310. The lift assembly 310 may include electric motors configured to raise and lower the lift arms and other actuators during operation. Other embodiments are also possible.

### C. Integrated Wheel Module

In certain embodiments, the integrated wheel module 242 may include an integrated motor, integrated steering, integrated active camber adjustment, and integrated active suspension. Each of these features may include electrical motors and drive shafts, worm drives, or other electrically controllable gear assemblies that may be used to interact with various components to implement the functionality. Further, control circuitry within the wheel module 242 may control operation of these electrical motors. In some embodiments, the control circuitry may receive signals from sensors, such as linear and angular acceleration sensors, temperature sensors, pressure sensors, and other sensors, and may automatically control one or more parameters to adjust operation of the various motors and elements in response to the received signals. Further, the control circuitry may receive control signals from an interface, such as a driver interface or other input interface, and may adjust one or more parameters to control operation of the various motors and elements in response to the received signals. Other embodiments are also possible.

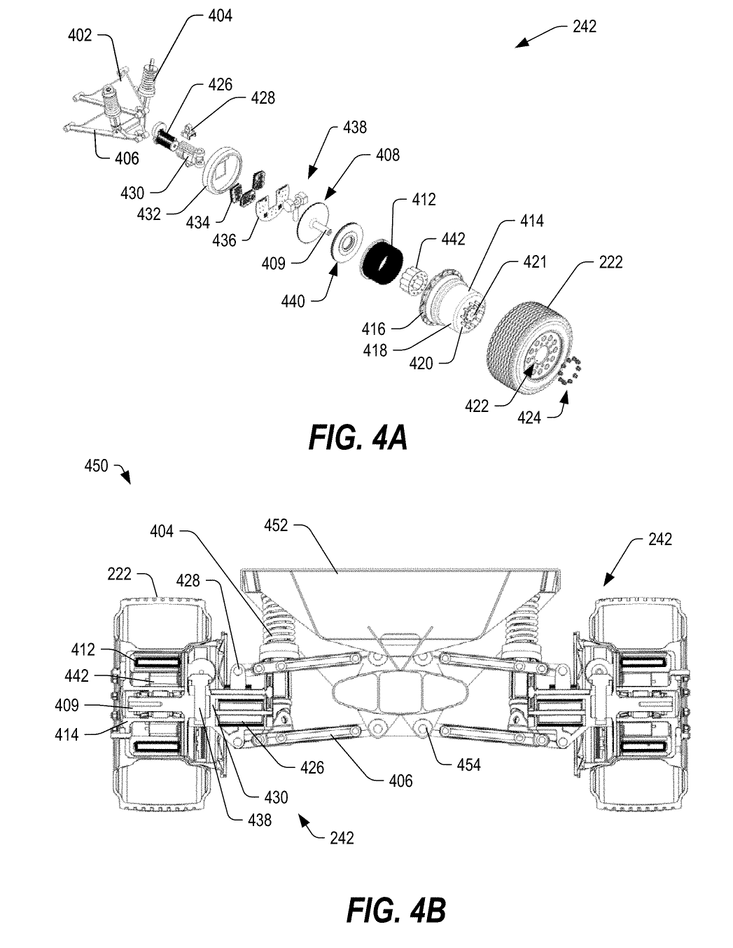

FIG. 4A depicts an exploded view 400 of components of an integrated wheel assembly 242, in accordance with certain embodiments of the present disclosure. The integrated wheel assembly 242 includes a frame interface structure configured to couple to a frame of a vehicle. The frame interface structure may include an upper frame 402 and a lower frame 406, each of which is configured to couple to a frame of a vehicle on one end. The upper frame 402 is coupled to a slider 428, and the lower frame is coupled to a camber housing 430.

A pair of coil assemblies 404 may be coupled between the lower frame 406 and the frame of the vehicle. Each coil assembly 404 may include a suspension coil positioned over an electromagnetic linear motor configured to dynamically adjust the suspension. Additionally, a second actuator element may be threadably coupled to the linear motor and can be adjusted positionally along a length of the linear motor to selectively adjust the compression of the suspension coil.

The camber housing 430 may be coupled to an articulated steering knuckle assembly 408 by a pin, which may allow the articulated steering knuckle assembly 408 to pivot relative to the lower frame 406 to turn the wheel 222.

The integrated wheel assembly 242 may include a drive motor 426 coupled to the body of the camber housing 430 and configured to move one of the camber housing and the slider 428 to adjust the camber angle of the wheel 222. The articulated camber slide 428 may be configured to slide back and forth along a guide portion of the camber housing 430. Further, the articulated camber slide 428 may include an opening sized to receive a pin to couple the articulated camber slide 428 to the upper frame 406. Additionally, a lower portion of the camber housing 430 may include an opening sized to receive a pin to couple the lower portion to a lower frame 406. The drive 426 may move the articulated camber slide 428 back and forth to dynamically adjust the camber angle (tilt) of the wheel 222 relative to the vehicle frame.

The integrated wheel assembly 242 may further include a stator assembly, which may include an orbital stator coil 412, a spindle hub (or articulated steering knuckle) 408 with a spindle 409, control electronics 434, coupling arrays 436, a king pin and associated motors (generally indicated at 438), communications and power arrays 440, and a power storage unit (e.g., a super capacitor 442, a rechargeable battery array, another charge storage unit, or any combination thereof). The integrated wheel assembly 242 may also include a rotor hub assembly 414, which may include an emergency brake rotor 416, a rotor 418 configured to fit over the orbital stator coil 412, and a rim mounting interface 420 configured to engage openings in a rim 422 of a tire 222. Lug nuts 424 may releasably fasten the rim 422 to the rim mounting interface 420.

In certain embodiments, the articulated steering knuckle assembly 408 may be coupled by a turning pin (or king pin) to a steering assembly 409 including a spindle configured to extend through the stator assembly and to engage a bearing race 421 of the rotor hub assembly 414. In some instances, an axle seal may be included to seal the bearing race 421 from environmental contaminants, such as moisture, dust, and debris. Other embodiments are also possible.

Control circuitry may be included within the stator assembly to control the motors, such as a worm drive, a direct drive, or other drive mechanism, to pivot the articulated steering knuckle assembly 408 about the turning pin 438. Further, the control circuitry may be configured to control a second drive (drive motor 426) to dynamically adjust a camber angle, which is the angle between a vertical axis of the wheel 222 and a vertical axis of the frame interface structure 402 (or the frame to which the frame interface structure 402 is attached). Further, the control circuitry housed within the stator assembly or coupled to the frame interface structure 402 may control one or more motors associated with the suspension coil assembly 404 to provide an active suspension, to adjust the compression of the coil to provide a passive neutral state, and to selectively raise or lower the wheel 222 relative to the frame of the vehicle.

It should be appreciated that the structure depicted in FIG. 4A is one possible example embodiment. In an alternative embodiment, components may be added, omitted, or combined and other components may be added or integrated to perform the functions without departing from the scope of the present disclosure.

FIG. 4B depicts a cross-sectional view 450 of a portion of a vehicle including a pair of integrated wheel assemblies 242, in accordance with certain embodiments of the present disclosure. Each wheel assembly 242 may be coupled to a frame 454 of a vehicle. Further, the vehicle may include an enclosure 452 configured to secure a plurality of batteries. In the illustrated example, each wheel module 242 may include all of the elements described above with respect to FIG. 4A, including the orbital stator coil 412 and the super capacitors 442 disposed within the hub 414.

In some embodiments, by positioning the super capacitors 442 inside of the orbital stator 412 and within the hub 414, electrical charge may be passed back and forth between the super capacitors 442 and the tuned combination of coils and inductance of the orbital stator 412. Thus, power loss through switching may be reduced by dumping excess charge into the super capacitors 442, thereby reducing the travel distance for the current dumping out of the coils of the orbital stator coil 412 or returning to the coils. At least some of the peak load and peak discharge may be recovered by temporarily storing the excess charge in the super capacitors 442. Other embodiments are also possible.

In the illustrated example of FIG. 4B, it can be seen that the upper and lower support arms 406 are coupled by bolts or pins to the support frame of the vehicle. It should be appreciated that each of these attachment points may provide a pivot point about which the end of the arm may pivot. Additionally, the slider 428 may articulate along the guide surface of the steering knuckle 430 in response to a drive motor to dynamically adjust the camber of the wheel 222 relative to the support structure of the vehicle. Other embodiments are also possible.

Further, the pin 438 and associated motors may be controlled to turn the wheel 222 about the pin 432. By providing a similar pin and associated motors in each wheel module 242, each wheel 222 may be turned independently relative to the support structure of the vehicle. Other embodiments are also possible.

In general, the integrated wheel module 242 provides a number of integration advantages. In one aspect, the motor delivers torque directly to the wheel 222, avoiding transmission loss. Additionally, the integrated super capacitors 442 can improve switching speed, capture regenerative and switching charges, and reduce peak switching loads. Further, integration of a king pin or other device 438 and associated motors makes it possible to turn each wheel 222 independently at the wheel itself, minimizing the cost and complexity of additional cables and connectors, thereby improving reliability. Additionally, integration of the drive 426 and the slider 428 configured to move along a guide surface of the camber housing 430 enables dynamic camber adjustment at each wheel 222, independent of every other wheel. Thus, each integrated wheel module 242 may adjust the camber to maintain consistent road surface contact. Moreover, the integration of the active suspension makes it possible to dynamically adjust the response of the suspension.

Dynamic suspension control provides numerous advantages over conventional suspensions. In one possible example, the wheel modules 242 may be configured to adjust the camber and the active suspension to prevent a load from tipping as the vehicle turns. In another possible example, the active suspension may be used to selectively raise or lower a wheel 222, for example, to avoid an obstruction or pot hole detected in the road surface. In the event of a flat tire, the wheel module 242 may be raised to allow the vehicle to continue traveling (distributing the load among the remaining wheels). The versatility provided by integrating these features into the wheel module 242 enables numerous advantages.

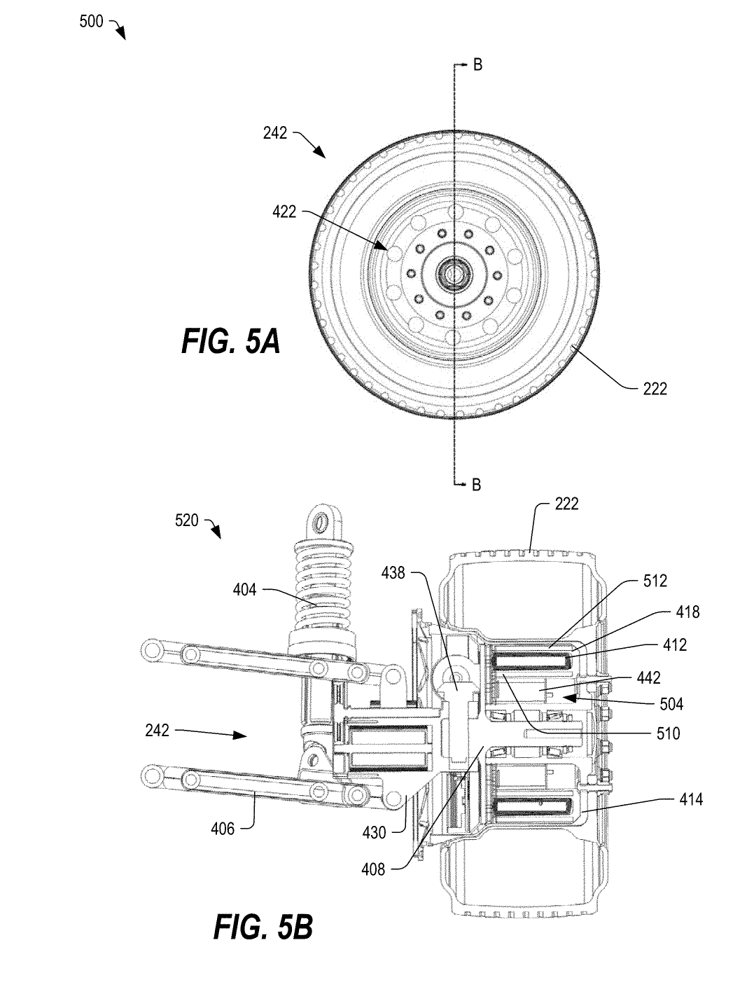

FIG. 5A depicts a side view 500 of an integrated wheel assembly, in accordance with certain embodiments of the present disclosure. The side view 500 depicts an integrated wheel module 242 including a pair of suspension assemblies 404 configured to attach to a frame of a vehicle. Each suspension assembly 404 may include a spring as well as one or more actuators (such as a linear motor) that may be controlled to dynamically adjust the suspension (height of the wheel, distance of the compression stroke, compression on the spring or coil, or any combination thereof). Further, the side view 500 depicts the rim 422 and a plurality of lug nuts 424, which may couple the rim to the rim mounting interface 420 of the rotor hub assembly 410.

FIG. 5B depicts a cross-sectional exploded view 510 of the integrated wheel assembly 242 taken along line B-B in FIG. 5A, in accordance with certain embodiments of the present disclosure. In the illustrated view 510, the rotor hub assembly 414 includes a rotor 418, which may include an inner circumferential magnet array 510 and an outer circumferential magnet array 512 configured to fit on either side of the orbital stator coil 412. Further, the rotor hub assembly 414 includes a central axis opening sized to receive an end of the spindle 409 of the steering hub 408. The rotor hub assembly 414 may include a second opening or space 504 sized to house the super capacitor 442, a rechargeable battery, or other charge storage device, which may be configured to store regenerative charge or other excess charge.

The orbital stator assembly 412 includes a central opening sized to receive the spindle 409 of the steering hub 408. Further, the orbital stator assembly may include an area sized to house circuitry 434, which may include power management circuitry, timing circuitry, control circuitry, and driver circuitry configured to control operation of the stator coil 412, the brakes, the steering drive motor, the camber drive motor, the linear motor of the active suspension, other functions, other circuits, or any combination thereof. In some embodiments, the circuit 434 may include a snubber circuit and capacitors to manage voltage spikes and to store energy from and deliver energy to the coils during switching.

The steering assembly 408 includes an opening 509 sized to receive the turning pin (or king pin) 438, which extends through a corresponding opening in the camber housing 430 and the steering knuckle 408 to provide a pivot point about which the king pin 438 can pivot to turn the wheel 222. A drive motor 426, which may include a threaded screw or other mechanism configured to engage the king pin 438, may be activated to turn the steering assembly 408 relative to the camber housing 430 by engaging teeth or threads on at least a portion of the king pin 438. Further,

In certain embodiments, the integrated wheel module 242 may include a motor configured to rotate the wheel 222 by applying electrical current to the coils of the orbital stator 412, which may interact with the magnetic fields of the permanent magnet arrays 510 and 512 of the rotor 418 to turn the wheel 222. By applying the current to the stator coil internal to the wheel, losses due to translation (such as from a transmission or other device converting rotary power from a drive shaft to the axle) can be eliminated, making the integrated wheel module 242 more efficient than a traditional electric motor.

In certain embodiments, the motor of the integrated wheel module 242 may be centered within the rim 422 such that the center of mass of the motor and the center of mass of the tire are aligned, reducing tire wear and improving overall performance. In certain embodiments, by moving the motor into the wheel, the center of gravity of the vehicle is lowered, because the weight of the motor is shifted from the frame of the vehicle to the tires, which are on the ground. By lowering the center of gravity, vehicular stability is improved. Other advantages and improvements may also be realized based on the improvements and advances discussed above with respect to FIGS. 1-5B.

It should be appreciated that the stator/rotor assembly may experience heating during operation. A cooling platter may be formed with protrusions configured to direct air flow across the stator/rotor assembly. In a particular embodiment, the cooling platter may be coupled to a portion of the integrated wheel assembly 242 that may be configured to rotate, such that the fins of the cooling platter may be enabled to direct air flow to cool the stator/rotor assembly during operation.

In certain embodiments, the stator/rotor assembly may be used to provide active braking, such as by adjusting current flow through the stator coil. In some embodiments, a brake rotor and associated brake pads may be included to assist the active regenerative braking or in lieu of active regenerative braking, depending on the implementation. In some embodiments, the brake rotor may be configured to couple to an exterior surface of a wheel hub 414. Other configurations and arrangements are also possible, depending on the implementation.

### D. Communication Arrays

In certain embodiments, the circuitry 434 internal to the integrated wheel module 242 may receive signals from a control system (such as control system 102), which can be remote. For example, the integrated wheel module 242 may receive control signals from a computing system within a cabin of the vehicle, from a smartphone or other computing device external to the vehicle, or any combination thereof. Further, internal circuitry of the integrated wheel module 242 may control operation of the various motors, including the stator/rotor assembly that drives rotation of the wheel 222, the linear motor of the active suspension, the motor associated with the active camber, and motors associated with steering. Communication between the circuits 434 and the stator may be accomplished via a plurality of conductive arrays and associated insulator platters. Electrical interconnections may be selectively formed between the stator and the conductive arrays through the insulator platters.

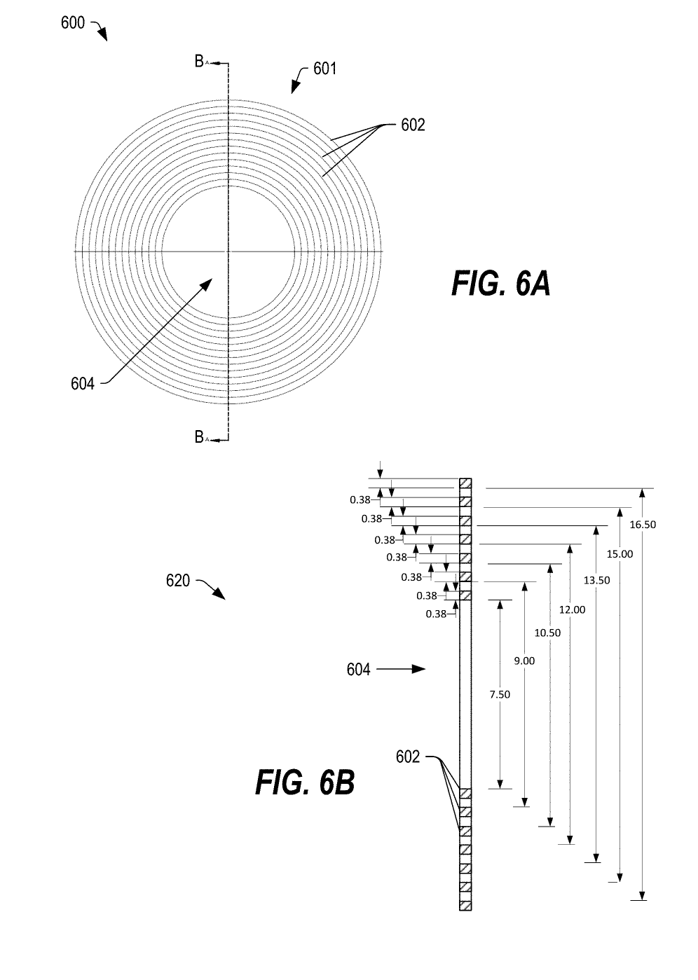

FIG. 6A depicts a circumferential radial power array 601, in accordance with certain embodiments of the present disclosure. The circumferential radial power array 601 may include a plurality of conductive rings 602 arranged circumferentially about an opening 604, which may be configured to receive the spindle 409 of the steering hub 408. In a particular example, the rings 602 may be spaced apart by a distance approximately equal to a thickness of the conductive rings 602. The power array 601 may be configured to deliver power and optionally control signals to the circuitry 434.

FIG. 6B illustrates a cross-sectional view 620 of the circumferential radial power array 601 taken along line B-B in FIG. 6A. As shown, the conductive rings 602 may be spaced apart by a distance that is similar to the width of the conductive ring 602. In this example, the conductive rings are approximately 0.38 inches in thickness and are spaced apart by gaps that may be approximately 0.37 inches. Other spacings and other conductor thicknesses may be used without departing from the present disclosure.

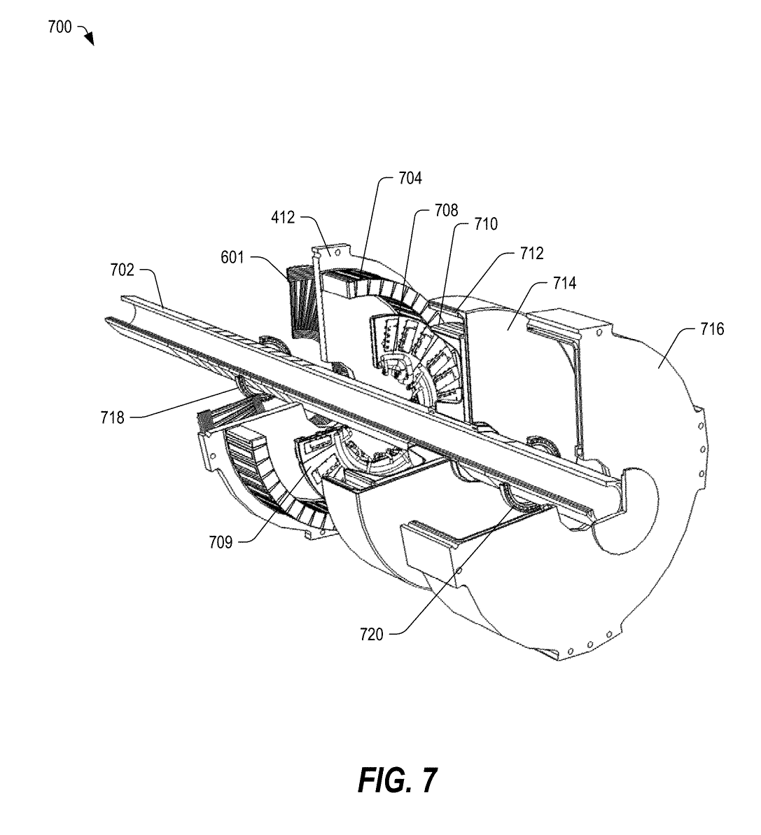

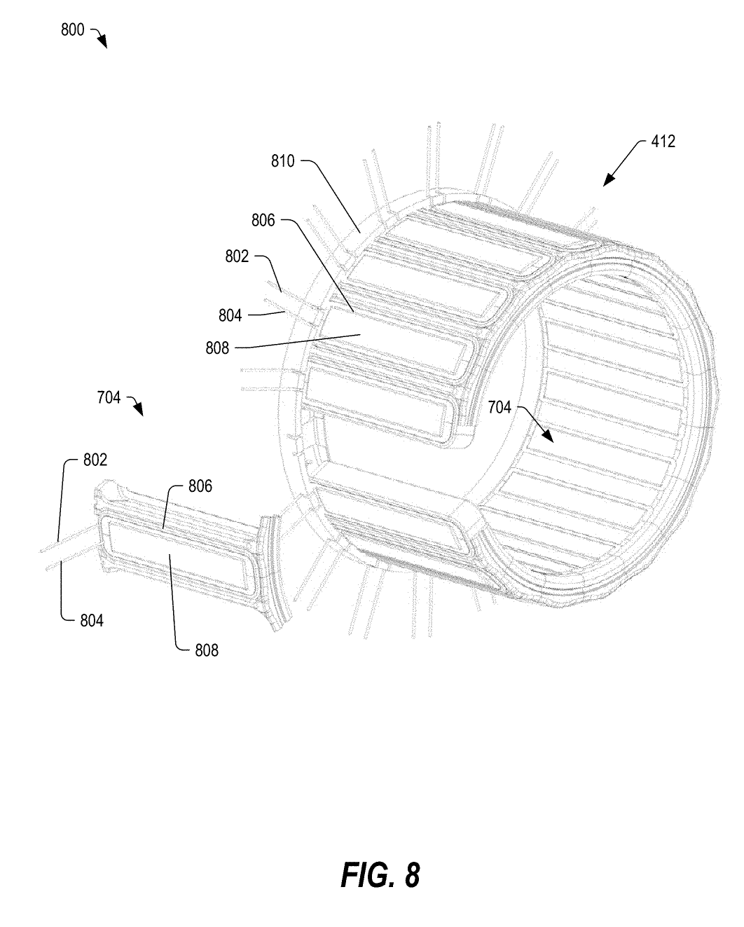

In conjunction with the motor components described above with respect to FIGS. 1-6B and the motor components described below with respect to FIGS. 7 and 8, the motor represents a direct drive, high torque, efficient, high power density, lightweight electrical machine design that can be implemented in a variety of contexts to drive a plurality of applications. The motor represents a new class of motor (and generator or alternator) based on a confluence of geometries, materials, manufacturing processes, power electronics, and control thereof.

The motor may include an array of independent magnetic circuits, which can be controlled independently to provide an adaptive polyphaser motor. Each coil of the stator assembly may be physically close to its own drive electronics (because the drive electronics 434 are encased within the housing together with the stator assembly 412), which enhances fast switching and low-loss energy recovery and reuse. In general, efficient fast switching improves (or even maximizes) the useful energy or work done within the electrical cycle of each coil as the magnet passes by, transferring energy between the dual airgaps (provided between the stator coil and the permanent magnets of an inner magnetic array and an outer magnetic array). In some embodiments, the drive electronics may include inductors and capacitors directly associated with each coil (as part of or in addition to a snubber circuit), which can reduce (or even minimize) the inherent (or parasitic) losses and acoustic noise, which generate heat and subtract from the overall efficiency of the motor. This can be a significant improvement over conventional compromises made in three, six, or other such variants of conventional phased motors.

Embodiments of a motor are described below that include a stator including a plurality of coils and a rotor including an inner magnetic array and an outer magnetic array, which arrays are formed from plurality of permanent magnets. The permanent magnets may be formed from a plurality of segmented magnets of the same size, composition, and magnetic properties, which magnets may be arranged and coated to provide a desired magnetic field arrangement with little or no magnetic field line leakage.

In general, the low magnetic field leakage provides significant advantages. First, significant torque (circumferential magnetic motive force) increase is achieved and overall weight reduction can be attained. The coils may be formed from a stator hoop-on-plate configuration. The rotors include dual magnetic arrays (also hoop-on-plate) formed from segmented magnetic arrays (or Halbach arrays) of permanent magnets, which complete a magnetic circuit on both sides of each stator coil without back iron, reducing weight (rotational inertia) and eddy current losses. The reduced weight enhances the balance of the motor and substantially reduces large radial forces usually exerted on the stator hoop. Further, the design and arrangement of the segmented magnetic array on both sides of the stator coils operates to confine the magnetic field, obviating the currents induced by stray magnetic fields, which could otherwise operate to heat and weaken structural materials. Further, the confinement of the fields enables the use of non-ferromagnetic materials, which allows for selection of lighter composite materials, reducing weight and heat retention. The switching circuitry and the coils may be cooled by integration of pyrolytic graphite (isotropically thermally very conductive material that is compatible with carbon fiber composite structures). Further, the motor components can be further shielded by magnetically and thermally conductive mu-metals shields. An Mu-metal is a nickel—iron soft ferromagnetic alloy with very high permeability, which can be used for shielding sensitive electronic equipment against static or low-frequency magnetic fields. The mu-metal shields can be electrically grounded (special bearing considerations), which, in conjunction with similar precautions in the stator plate, electronics housings, and conductor shielding can result in virtually no detectable magnetic signature. This is desirable in submarines and advanced minesweeping vessels and vehicles.

In certain embodiments, the magnetic arrays contain almost all of the magnetic field from the permanent and electromagnets. Further, power density (in kW/kg and KW/liter terms) is enhanced because sources of losses are minimized, remaining loss heat is actively removed, and lightweight materials are able to be utilized due to the advantageous compact geometry and manufacturable modular design of these electrical machines.

In some embodiments, a control system may interact with drive electronics circuitry for each coil to control each coil independently. In some embodiments, the control system may selectively activate some, but not all, of the coils to allow for segmented, individual actuation. In some embodiments, the addition of a number of sets or “pole pairs” of inner and outer magnetic sources can be added to abate the magnetic alignment or “magnetic locking” of a rotating assembly or rotor. The control system may control the electromagnets asynchronously as desired to drive the rotation. Further, the electromagnets may be controlled using a plurality of different phases of a periodic signal, such as a square wave or a sinusoidal signal.

In some embodiments, the electromagnets may be driven by a selected number of phases, where the number of phases may be selectively controlled to achieve a desired motive force. A control circuit or system may be configured to control the signals to drive the electromagnets via the drive electronics of each coil. Further, the control circuit may selectively activate some, but not all, of the electromagnets at selected phases. For example, to reduce power consumption, once the rotor is moving at a selected speed, the control circuit may selectively disable some of the electromagnets and selectively drive other electromagnets to maintain the selected speed, while reducing overall power consumption. Other embodiments are also possible.

In some embodiments, the motor may include a plurality of magnetic circuit modules, each of which may include an inner magnetic source, a central magnetic source, and an outer magnetic source. The central magnetic source may be coupled to a stator, which is configured to drive a rotor that includes the inner and outer magnetic sources. The magnetic sources may be permanent, electromagnetic, or any combination thereof. The magnetic sources may be arranged in a variety of arrays. In some embodiments, the magnetic poles of the inner magnetic sources may be offset by one-half of a pole pitch relative to the outer magnetic sources. In some embodiments, the magnetic pole alignment of the central magnetic source may be as close to parallel to a center line between the inner magnetic source and the outer magnetic source. When the inner and outer magnetic sources are arranged in circular arrays, the pole alignment can be parallel to a tangent line of the circular arrays at a center point of the central magnetic source.

In some embodiments, a motor may include a rotor having an inner circumferential array of magnets and an outer circumferential array of magnets separated by an air gap defining a channel. The motor may further include a stator assembly including a plurality of magnetic sources configured to fit within the channel. In some embodiments, the rotor is configured to rotate relative to the stator in response to magnetic fields presented by the magnetic sources of the stator assembly. Other embodiments are also possible.

In some embodiments, the magnetic sources of the stator assembly may be electromagnetic and may be controlled by a control circuit to drive the rotor. The magnetic coils of the stator may consume power according to the resistance as well as the inductance provided by the magnetic coil. The control circuit may drive the stator using direct current (DC) power, but the time-varying nature of the current leaving the coil implicates fringing and skin depth related issues with respect to the surface area of the conductor. By utilizing an insulated gate bipolar transistor (IGBT) or other insulated circuit for switching, the current from the coil may be selectively directed onto a power bus, which can have a large surface area. The circuitry may be mounted to the stator and immersed in oil, such as a silicone-based oil, for cooling. Further, in some embodiments, the stator coils may be turned horizontally and the core of the coils may be driven into partial magnetic saturation to enhance the motive force applied to the rotor.

FIG. 5 depicts an exploded view of an embodiment of an electric motor 700 within the integrated wheel module 242 of each of the wheels, in accordance with certain embodiments of the present disclosure. The motor 700 may include a stator assembly 412 and a rotor 714. The motor 700 may include a crank shaft 702, which may extend through an opening of the stator assembly 412 and which may be coupled to the rotor 714 so that the rotational movement of the rotor 714 may turn the crank shaft 702. In some embodiments, at least a portion of the stator assembly 412, the rotor assembly 714, and a housing cover 716 may be formed from carbon fiber or other composite materials.

The stator assembly 412 may be bolted to a frame or housing of a structure, such as a frame of a vehicle, a housing of a pump, or some other structure, so that the electromagnetic force can cause the rotor 714 to turn relative to the stator assembly 412 and the structure. The stator assembly 412 may include a plurality of coil assemblies 704, each of which may include a wire coil wrapped around a laminate core. The stator assembly 412 may be coupled to control circuitry and to one or more power sources (such as batteries) through a radial circumferential radial power array 706, which may be electrically coupled to the coil assemblies 704 and to an insulated gate bipolar transistor (IGBT) circuit 709, which may include a cooling assembly 708 as well as a snubber circuit and capacitors for temporary storage of voltages during current switching operations in order to recover and reuse power from the coils 704 and without having to deliver the power to an external circuit, which could introduce losses. The IGBT circuit 709 may be an embodiment of the circuitry 434 in FIG. 4.

In some embodiments, the cooling assembly 708 can include a cooling arch and power distribution cooling plates configured to cool the coils 704 and associated circuitry 709, which may heat in response to current flow through the coils and switching the current flow on and off. The IGBT circuit 709 may be configured to operate an electrical switch to provide high efficiency and fast switching between the ends of the coils 704 and the snubber circuit and capacitors.

The motor 700 may further include the rotor 714, which includes an inner magnetic array 710 and an outer magnetic array 712 spaced apart by an air gap that defines a channel sized to receive the electromagnetic coils 704 of the stator 412. The magnets of the magnet arrays 710 and 712 may be configured in an array where the magnets are arranged to provide a spatially rotating pattern of magnetization. The permanent magnets of the arrays 710 and 712 can provide a magnetic flux distribution that interacts with the magnetic fields produced by current flowing through the coils 704 of the stator assembly 412. The interaction between the magnetic flux distribution and the induced magnetic fields may accelerate the rotor 714 rotationally about an axis corresponding to the axis of the crank shaft 702.

The motor 700 may further include a housing cover 714, which may couple to a substrate of a stator assembly 412 to form a sealed enclosure. In some embodiments, the stator assembly 412, the coils 704, the IGBT circuit 709 (including capacitors and snubber circuits), and the cooling assembly 708 may be sealed within the enclosure, which may be filled with an oil to facilitate cooling of the circuitry. In some embodiments, the oil may be circulated using a pump or other controllable device to facilitate cooling of the components. Further, in the illustrated example, bearings 718 and 720 are depicted. Other components may also be included, which are omitted here for ease of discussion.

In some embodiments, the magnetic arrays 710 and 712 may be formed by a plurality of small magnets, which may be coated to facilitate magnetic field containment and which may be interconnected and arranged to direct magnetic field lines to remain within the periphery of the arrays 710 and7. By containing the magnetic fields with the magnets themselves, external structures for further containment of the magnetic fields may be omitted. In some embodiments, the housing cover 714, for example, may be formed from composite material. The ability to use non-ferromagnetic materials allows the motor to be formed from a relatively light structural material, reducing weight loads and making it easier to turn the rotor 714. Moreover, the lighter material can reduce heat retention and provide for a more efficient motor design. Further, the housing cover 716 may be configured for a variety of implementations, including a wheel hub for example. Other embodiments are also possible.

The motor 700 is implemented as a direct drive, high torque, efficient, high power density, lightweight electric machine design that can be designed to enable many applications, including motors, actuators, pumps, generators, other systems, or any combination thereof. A new class of motor and generator or alternator is also possible from the confluence of geometries, materials, manufacturing processes, power electronics and control thereof, which are described herein.

Each coil 704 of the stator 412 of this adaptive, polyphase motor 700 is close to its own drive electronics or circuitry 709. Efficient fast switching of the current into and out from the coils 704 maximizes the useful energy or work done in the electrical cycle of each coil 704 as the magnet passes by, transferring energy between the dual airgaps (between the coil 704 and the inner magnet array 710 and the outer magnet array 712). The circuitry 709 includes inductors and capacitors (as part of or in addition to a snubber circuit) directly associated with each coil 704. During switching, power from the coil 704 may be stored in a capacitor (and/or snubber circuit) close to the coil 704, reducing the inherent (parasitic) losses and acoustic noise, which generate heat and subtract from the overall efficiency of the motor 700. This reduction in losses and heating can provide a significant improvement in motor architectures, particular as the number of phases of the motor increases.

The motor 700 provides significant torque (circumferential magnetic motive force) increases and weight reduction. In particular, the stator assembly 412 is a hoop-on-plate configuration, which interfaces with dual rotors 714 (also hoop-on-plate) comprised of segmented magnetic arrays (such as Halbach arrays) of permanent magnets. The magnetic arrays 710 and 712 cooperate to complete the magnetic circuit on both sides of the stator coil 704 without back iron, reducing weight (rotational inertia) and eddy current losses. The omission of back iron allows for lighter materials and improved balance of the system, substantially reducing the large radial forces usually exerted on the stator hoop assembly 412.

The segmented magnetic arrays confine the magnetic field, obviating the currents induced by stray magnetic fields, which otherwise heat and weaken structural materials and reduce overall efficiency. The magnetic arrays contain almost all of the magnetic field from the permanent and electromagnets. The motor can be shielded by magnetically and thermally conductive mu-metal shields. The mu-metal may include a nickel—iron soft ferromagnetic alloy with very high permeability, which can used for shielding sensitive electronic equipment against static or low-frequency magnetic fields. The mu shields may be electrically grounded. The stator plate, electronics housings and conductor shielding can result in virtually no detectable magnetic signature, which may be desirable in magnetically sensitive applications, such as in submarines and advanced minesweeping vessels and vehicles.

The cooling circuitry 708 can include an integrated pyrolytic graphite (isotropically thermally very conductive material that is compatible with carbon fiber composite structures). Other cooling techniques may also be used, including thermal oil cooling and other cooling techniques.

The motor 700 enhances the overall power density (in kW/kg and KW/liter terms) because all sources of losses are minimized, remaining loss heat is actively removed, and lightweight materials are able to be utilized due to the advantageous compact geometry and manufacturable modular design of the motor. Further, load paths from the stator assembly 412 to the stator plate to the outer motor housing 716 and onward to the load are short, direct and take full advantage of large diameters and high material modulus, resulting in a compact, stiff, quiet machine that is easily coupled to the load.

Machine health management (superior to monitoring) is enabled by monitoring temperatures and electrical characteristics along with baselines in each coil and power electronics unit at each coil individually. Further, performance (torque at desired Revolutions per Minute (RPM)) can be maximized within limits of machine health management on a continuous or burst mode basis, within each coil and power electronics unit. Normally efficiency can be maximized to minimize losses and heat generated at the desired power. Further, each coil 704 can be controlled independently to provide a desired performance and efficiency.

FIG. 8 depicts a perspective view 800 of the stator assembly 412 of the motor 700 of FIG. 7 (or of earlier figures), in accordance with certain embodiments of the present disclosure. The stator assembly 412 may include a base 810 coupled to a plurality of stator coils 704. Each stator coil 704 may include a wire or coil 806 wrapped around a laminate core 808. The wire or coil 806 may include an input 802 and an output 804 coupled to a control circuit (such as the control system 102 in FIG. 1 or the integrated circuitry 434 in FIG. 4, or both).

The stator assembly 412 may include a plurality of stator coils 704 arranged circumferentially about a center axis. The inner magnet array 710 and the outer magnetic array 712 of the rotor 714 may be configured to fit over the stator coils 704 to interact magnetically with the stator coils 704. Other embodiments are also possible.

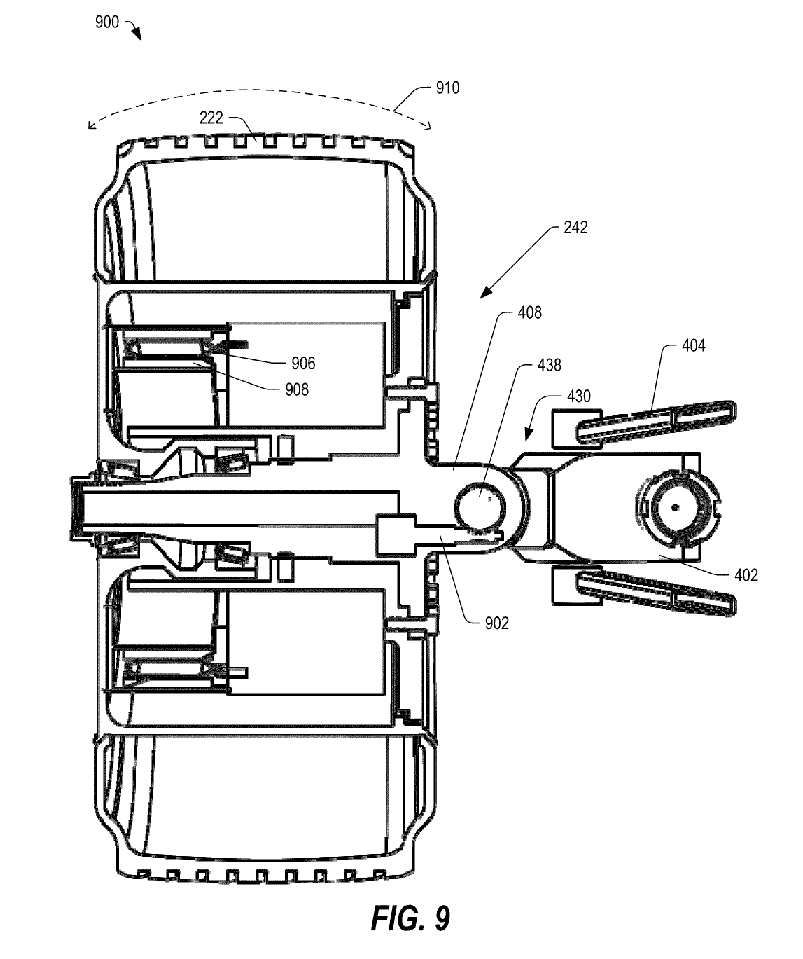

FIG. 9 illustrates a cross-sectional view 900 of the integrated wheel module 242 of FIG. 2-8, in accordance with certain embodiments of the present disclosure. In the illustrated example, the camber housing 430 is coupled to the steering hub 408 via a king pin 438. In this example, the upper frame 402 is coupled to a slider 428 (shown in FIG. 4), and the lower frame 406 (in FIG. 4) is coupled to active coil assemblies 404. Further, the integrated wheel module 242 may include a motor configured to turn a threaded drive screw 902 configured to engage threads (gear) of the king pin 438 to turn the wheel 222 about the pivot point formed by the king pin 438. The turning of the wheel 222 is depicted by the arrow 910.

In contrast to earlier depicted embodiments, this particular implementation uses a screw to turn the king pin 438. In other embodiments, a motor associated with the king pin 438 may be used to turn the wheel 222. In either case, steering is implemented within the wheel module 242 itself, in response to control signals. By implementing steering as an electronic function, mechanical steering mechanisms of conventional vehicles can be omitted, removing a potential failure point.

In this particular example, rotation of the threaded drive screw 902 in a first direction causes the wheel 222 to turn in a first direction about the king pin 438. Rotation of the screw 902 in a second direction causes the wheel to turn in a second direction about the king pin 438. Other embodiments are also possible. It should be appreciated that the number of active coils 404, the support structure, the motor used to turn the wheel about the king pin 438, and other specific details may vary without departing from the spirit of the present disclosure.

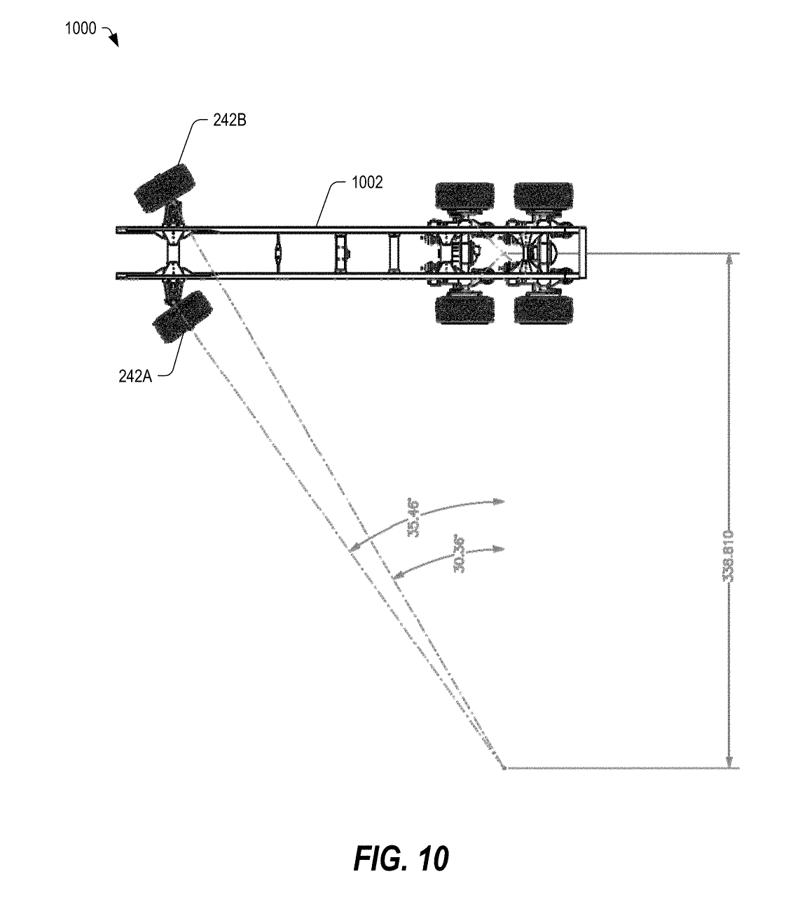

FIG. 10 depicts a vehicle system 1000 including a frame 1002 and including two wheel assemblies 242A and 242B adapted to turn, in accordance with certain embodiments of the present disclosure. As shown, the turn radius of the inside tire 242A is approximately 35.46 degrees, while the turn radius of the outside tire 242B is approximately 30.36 degrees. In this example, the rear tires do not turn. By locking the rear tires to the structure 1002 such that the rear tires are held straight, the rear tires are dragged into and through the turn, causing wear to the tires 222.

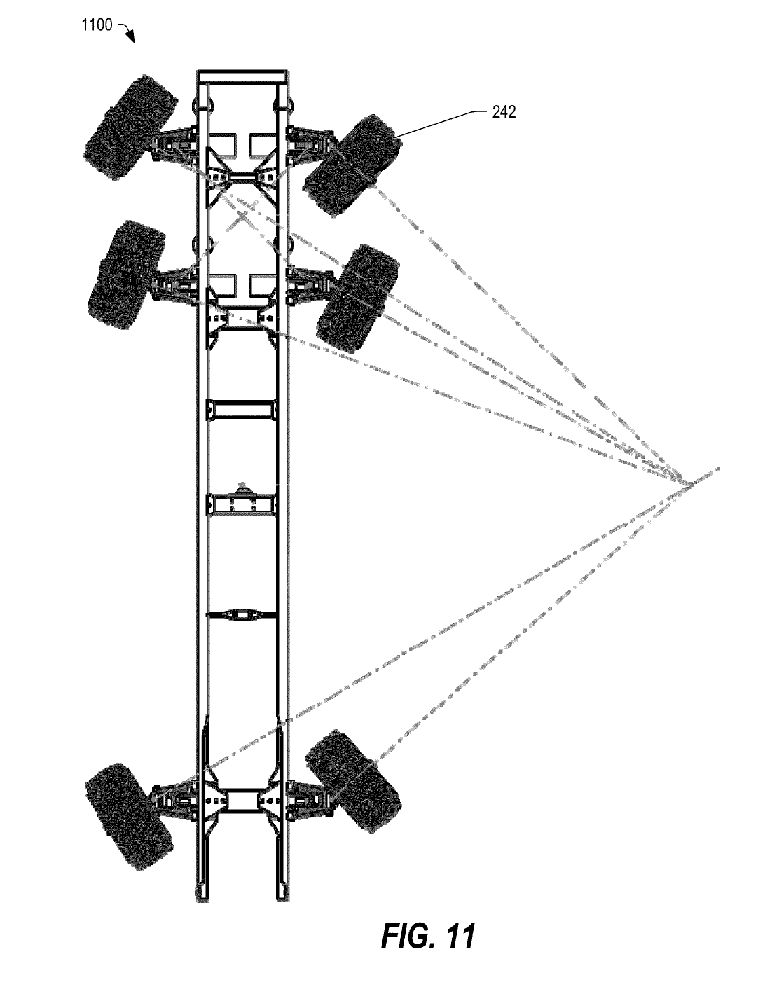

FIG. 11 depicts a vehicle system 1100 including a frame and including six integrated wheel assemblies 242, each of which is adapted to turn independently from the others, in accordance with certain embodiments of the present disclosure. In this example, each of the wheel assemblies 242 may be independently turned, providing six-wheel steering. In particular, each wheel assembly 242 may be turned independently to a selected angle to provide a desired turn radius for the position of the particular wheel 222 relative to the frame of the vehicle system 1100 and for the depth of the turn. In the illustrated example, each of the wheels may continue to steer independently throughout the turn, thereby improving tire contact with the road surface, improving stability, reducing the turn radius, reducing wear on the tires, and improving handling and safety.

In the illustrated example, each of the wheel modules 242 may be controlled independently by the control circuitry 434 within the wheel module 242 and/or by the control system 102 in FIG. 1, for example, in response to a control input from the driver. In some embodiments, the wheel modules 242 may also respond to other inputs, such as sensor inputs. In an example, in response to detecting slip, the wheel modules 242 may selectively control the turn angle to maintain control, enhancing overall safety.

It should also be noted that toe angle as well as camber angle can be adjusted dynamically and instantaneously at a selected location. Further, the camber angle can be dynamically adjusted to adjust the center of gravity and to position to load to enhance traction at a selected location. In general, excessive toe-in can cause the tire to scrub on the outboards and thereby shorten the tire-life. Too much toe-out can cause the inboard edges to wear out. In some embodiments, overall steering response can be improved with toe-out, while straight-line stability can be improved with toe-in. By adjusting the wheel modules dynamically to take advantage of such enhancements, the integrated wheel modules 242 may be dynamically adjusted to enhance steering responsiveness and straight-line stability, depending on the driving conditions and in response to user input.

Further, in some embodiments, toe-in or toe-out can be used for to manage tire-temperature. For example, for racing-tires, it can be important to reach a certain temperature in order to deliver maximum performance/grip. If the tires are too cool, then the toe can be adjusted to cause a “scrubbing” (heating) effect, which may also scrub the tires clean, providing extra grip for braking and cornering. Other adjustments are also possible to dynamically achieve selected performance parameters.

The integrated wheel module 242, as discussed above, includes an active camber adjustment feature that allows the system to dynamically and independently adjust the camber of the wheel relative to the vehicle by activating linear motor that causes the wheel to tilt toward or away from the vehicle (or to maintain a neutral camber). The active camber in conjunction with the active suspension allows the integrated wheel module to actively manage the wheel camber to ensure that the contact patch of the tire remains fully engaged and flat in the way that the tire was designed despite the lean of the vehicle. Thus, active camber may enhance the vehicle's stability rather than going against the stability in respect to the center of gravity shifting into and out of a turn, such that the center of gravity shifts outside of the outside wheels as the load leans. Thus, the active suspension and the active camber can cooperate to prevent rollovers. Additionally, as the weight transfers to the front wheels during braking, the active suspension and the active camber cooperate to maintain contact of all of the wheels, maximizing the grip, the traction, the lateral stability, the ability to steer, and most of all the ability to brake the vehicle in a straight line or direction consistent with the steering input.

Since each wheel module 242 may have an independently controlled active camber, the suspension and the active camber cooperate to ensure that the tire's contact with the ground is maximized, thus allowing thrust vectoring and lateral stability of the vehicle, which stability is further enhanced because the wheels can steer independently so that there is a possibility for active thrust vectoring by steering if necessary. For instance, in the case of a large truck that is subject to wind gusts where the back of the trailer is affected, the rear wheels can steer into the wind, maintaining the alignment of the truck with the direction of motion as opposed to allowing the rear of the truck to sway or drift. Thus, instability due to such wind-induced shifting (which can lead to jackknifing) can be reduced. Further, the reaction of the active driven wheel and the steering can be much faster than the traditional pneumatic brakes, which allows for the amount of braking to be adjusted like ABS brakes are on trucks, maximizing the straight-line braking and the ability to follow the direction that is set by the steering indication of the truck driver. The active suspension and the active camber cooperate to keep all of the wheel surfaces maximally connected to the road and working in combination to ensure that the vehicle is operated safely within its lanes, staying on the highway and avoiding jackknifing, avoiding inside trailing rear wheel lift that is common in trucks today, and maximizing the safety driver experience as the whole vehicle slows down rather than being pushed by the trailer into the turn.

In the above discussion involving the trailer, it should be understood that the wheels of the trailer could be replaced with wheel modules 242 as described above. In one possible embodiment, the wheel modules 242 provide the wheels for a trailer that is being towed by a diesel truck. In this instance, the wheel modules 242 could operate as power generation units that parasitically generate sufficient current to maintain a substantially neutral spin resistance and to monitor load and other conditions. In such a case, the power electronics of the wheel module 242 may be configured to wake up and perform load balancing, active camber adjustments, and active suspension adjustments as needed to accommodate sensed conditions. In other embodiments, each of the wheels of the vehicle may include integrated wheel module 242 to provide dynamic steering, dynamic and continuous camber adjustments, dynamic and continuous active suspension adjustments, and to contribute to acceleration and braking of the vehicle. In some embodiments, the wheel modules 242 of the trailer may be coupled to a control system via one or more communications links, including wired communication lines, shared communications buses, wireless communication links, or any combination thereof. If a wireless communication capability is used, the I/O interfaces 114 in FIG. 1 may include one or more wireless transceivers, and each wheel module may also include a wireless transceiver. In some examples, the wheel modules may be configured to communicate directly with one another and with a central control.

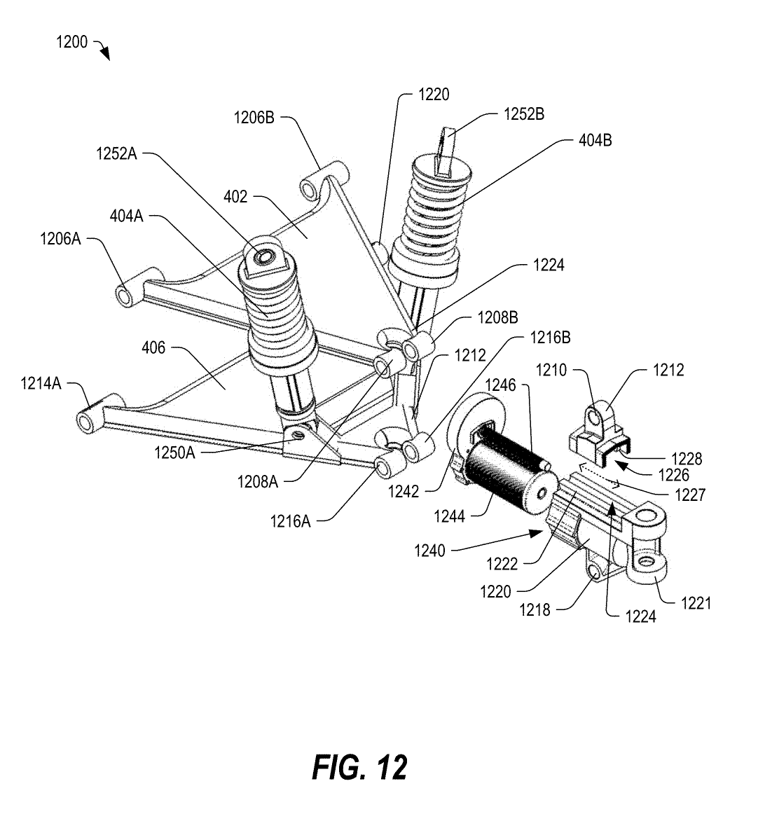

FIG. 12 depicts an exploded perspective view of structural components 1200 configured to provide a dynamic camber adjustment, in accordance with certain embodiments of the present disclosure. The structural components 1200 may include an upper mounting frame 402 and a lower mounting frame 406. The upper mounting frame 402 includes frame attachment elements 1206A and 1206B, which may be cylindrical structures sized to receive fasteners (such as a bolts) to couple the frame attachment elements 1206A and 1206B to corresponding features on the frame of the vehicle. The upper mounting frame 402 further includes slider attachment elements 1208A and 1208B, which may be cylindrical structures sized to receive a fastener (such as a bolt) to couple the slider attachment element 1208A and 1208B to a corresponding receptacle 1210 of a slider 1212.

The lower mounting frame 406 includes frame attachment elements 1214A and a corresponding element that is obscured from view by the upper mounting frame 402. The frame attachment element 1214A and its corresponding element on the obscured edge of the lower mounting frame 1204 may include cylindrical structures sized to receive fasteners (such as bolts) to couple the frame attachment elements 1214 to the frame of the vehicle. The lower mounting frame 406 further includes camber housing attachment elements 1216A and 1216B, which may be cylindrical structures sized to receive a fastener (such as a bolt) to couple the camber housing attachment elements 316A and 316B to a corresponding receptacle 1218 of a camber housing 1220.

The camber housing 1220 may include a guide element 1222 including a central groove 1224 forming tracks along an upper surface of the camber housing 1220. The guide element 1222 may be sized to receive a corresponding recess 1226 of the slider 1212. The recess 1226 includes side walls spaced apart to fit over the guide element 1222 of the camber housing 1220. The recess 1226 may include a ridge or extension 1228 within the recess 1226 to engage the central groove 1224. The slider 1212 may be configured to slide back and forth along the guide element 1222 as indicated by the phantom arrow 1227.

The camber housing 1220 may define an enclosure 1240 sized to receive a portion of an actuator 1242, which may include a worm drive having a rotatable gear 1244 configured to engage corresponding threads of an articulating shaft 1246 configured to move the slider 1212 along the guide element 1222. The actuator 1242 may be an embodiment of the drive 426 in FIG. 4. The camber housing 1220 may be an embodiment of the camber housing 430 in FIG. 4. The camber housing 1220 may further include a coupling 1221 configured to receive a king pin 438 or other fastener to secure a steering knuckle 408 or other structure to the camber housing 1220. In some embodiments, a wheel 222 including a rim and a tire may be coupled to the steering knuckle. In a particular example, the actuator 1224 may be controlled to adjust the position of the slider 1212 relative to the housing 1220 to adjust the camber angle of the wheel 222.

The structural components 1200 may further include suspension springs 404A and 404B. The suspension spring 404A may be coupled at a proximal end to a spring attachment element 1250A of the lower mounting structure 406 via a fastener, such as a bolt. The distal end of the suspension spring 404A may include a frame attachment element 1252A configured to couple to a corresponding attachment feature of the frame of the vehicle. Similarly, the suspension spring 404B may be coupled between a spring attachment element 1250B (which is obscured by the upper mounting frame 402) and a frame attachment element 1252B, which may be coupled to the frame of the vehicle.

It should be understood that the structural components 1200 may be included with each of the wheel modules of the vehicle, making it possible to dynamically adjust the camber angle of each wheel independent from every other wheel. Thus, each wheel can have an independently adjustable camber angle to maintain consistent road surface contact in various road conditions and in response to changing directions. Further, it should be appreciated that the camber angle adjustments may be implemented dynamically as the vehicle is in motion, in order to maintain a desired contact patch between the tire and the road surface.

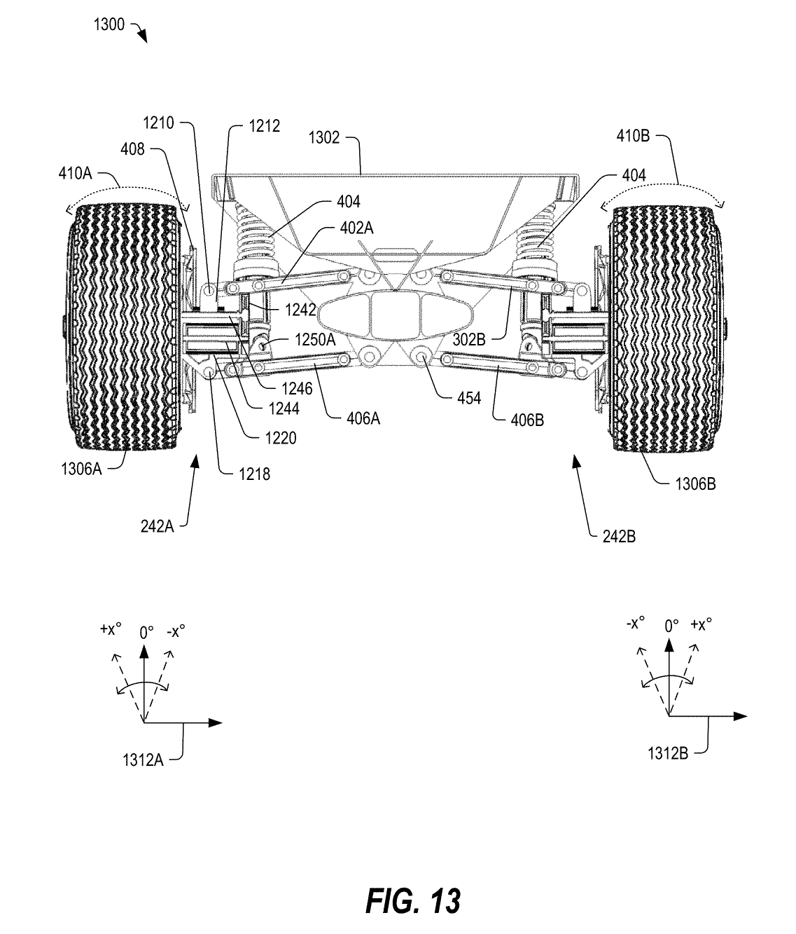

FIG. 13 depicts a front perspective view of a portion of a vehicle 1300 including wheel modules 242A and 242B configured to provide dynamic camber adjustments independently, in accordance with certain embodiments of the present disclosure. The vehicle 1300 may include a frame 1302 coupled to wheel modules 242A and 242B, each of which includes the structural components 1200 of FIG. 12, a respective tire 1306A and 1306B, and a steering knuckle 408 connected to the coupling 1221 of the camber housing 1220 in FIG. 12.

In the illustrated example, by controlling the actuator 1242, the rotatable gear 1244 is configured to engage corresponding threads of the articulating shaft 1246 to move the camber housing 1220 relative to the tire 1306 and the frame 1302. The slider 1212 may move along the guide 1222 (shown in FIG. 12) while the receptacle 1218 of the camber housing 1220 remains rigidly coupled to the lower mounting frame 406A. The bolt extending through the receptacle 1218 and the camber housing attachment elements 1216 of the lower mounting frame 406 provides a pivot point about which the camber housing 1220 may rotate, allowing the tire 406A to tilt to adjust the camber angle as indicated by the arrow 1310A

In general, the slider 1212, the guide element 1222 (in FIG. 12), the camber housing 1220, the upper mounting frame 402, the lower mounting frame 406, and the actuator 1242 (with the gear 2144 and the shaft 1246) allow the camber of each tire 1306A and 1306B to be controlled dynamically and independently. As shown, the tire 1306A and the tire 3106B may be tilted according to the arrows 1310A and 1310B, respectively. In particular, the tires 1310A and 1310B are shown with camber angles of zero, which represents an angle that is approximately perpendicular relative to the ground. The tire 1306A can have an adjustable camber angle 1312A that can be controlled to provide an adjustable camber angle 1312A that can range from a positive camber angle to a negative camber angle. The tire 1306B can have an adjustable camber angle 1312B that can be controlled to provide an adjustable camber angle 1312B that can range from a positive camber angle to a negative camber angle. The adjustable camber angles 1312A and 1312B may be adjusted independently from one another, both in terms of the camber angle and the timing of the variation.

In some embodiments, a control system or control circuit (such as the system 102 in FIG. 1) may be housed within an enclosed portion of the frame 1302 of the vehicle 1300 and may be coupled to the actuator 1342 and to a plurality of sensors (not shown) via wired connections. In some examples, the control circuit or control system may determine various parameters of the tire, the road pitch, the road conditions, and the steering control signals and may selectively adjust the camber angle of each of the tires 1306A and 1306B. In an example, during a turn, the tire 1306A may be adjusted to provide a first camber angle 1312A, and the tire 1306B may be adjusted to provide a second camber angle 1312B. The first and second camber angles 1312A and 1312B may be adjusted to have different camber angles (one positive and one negative, one negative and one more negative, one zero and one negative, etc.). Any combination of positive, negative, and zero camber angles may be provided, depending on the desired performance characteristics. It should be appreciated that the camber angles may also differ in magnitude, such that the negative camber angle of one tire may have an absolute value that is greater than a positive camber angle of another tire, and so on. In a turning situation involving a vehicle having multiple tires, the tires 406 on the outside of the turn may each have a negative camber angle that differs from that of an adjacent tire to enhance the tire contact patch for each tire independently. Similarly, the tires 406 on the inside of the turn may each have a positive camber angle that differs from that of an adjacent tire to enhance the tire contact patch for each tire independently. Other embodiments are also possible.

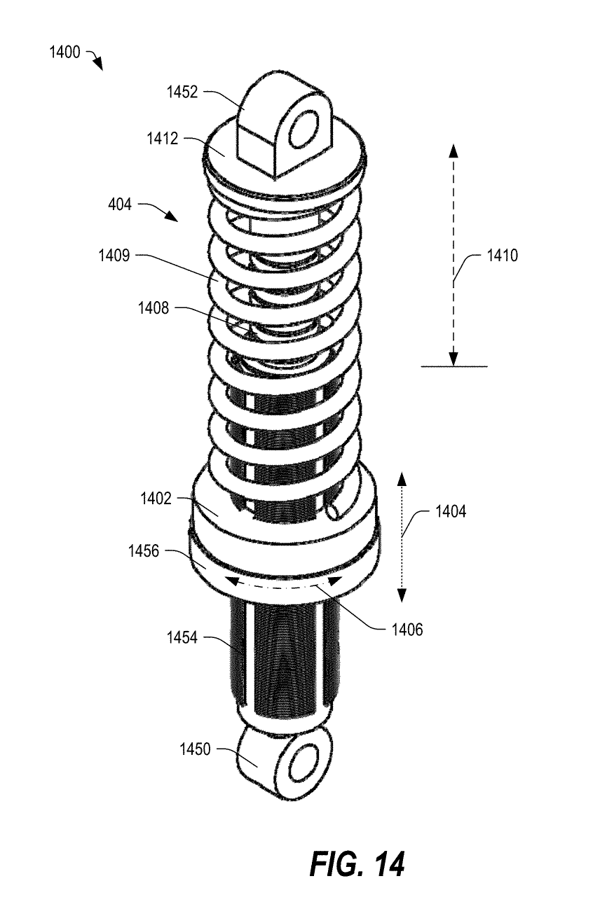

FIG. 14 depicts a perspective view of an apparatus 1400 including an active suspension assembly 404 having adjustable compression, in accordance with certain embodiments of the present disclosure. The active suspension assembly 404 may include the linear actuator 1454 with an extendable piston 1408, which may extend or retract in a direction indicated by arrow 1410. The linear actuator 1454 may include an attachment feature 1450 configured to couple to a spring attachment element 1450 of a lower mounting frame 406. Further, the extendable piston 1408 may include the frame attachment element 1452 and a coil stop 1412.

The active suspension assembly 404 may further include the drive element 1456 configured to engage threads on an exterior surface of the linear actuator 1454. The drive element 1456 may be configured to rotate about the exterior surface of the linear actuator 1454 as indicated by the arrow 1406 to advance along a longitudinal axis of the linear actuator 1454 as indicated by the arrow 1404. In some embodiments, the drive element 1456 may be coupled to or may include a coil stop 1402.

In some embodiments, the drive element 1456 may be adjusted to apply a desired compression to the coil 1409 and to maintain that compression passively based on engagement with the threads on an exterior surface of the linear actuator 1454. In an example, when the vehicle is parked, the drive element 1456 may be adjusted to compress the coil 1409 to provide a neutral loading condition, allowing the linear motor to be turned off and allowing the coil 1409 to assume the load. The drive element 1456 can be used to achieve a neutral suspension state. Other embodiments are also possible.

In some embodiments, the coil stop 1412 and the coil stop 1402 may cooperate to apply compression to the spring or coil 1409. In an example, extension or retraction of the plunger or piston 1408 and rotation of the drive element 1456 may cooperate to adjust the compression applied to the spring or coil 1409. Other embodiments are also possible.

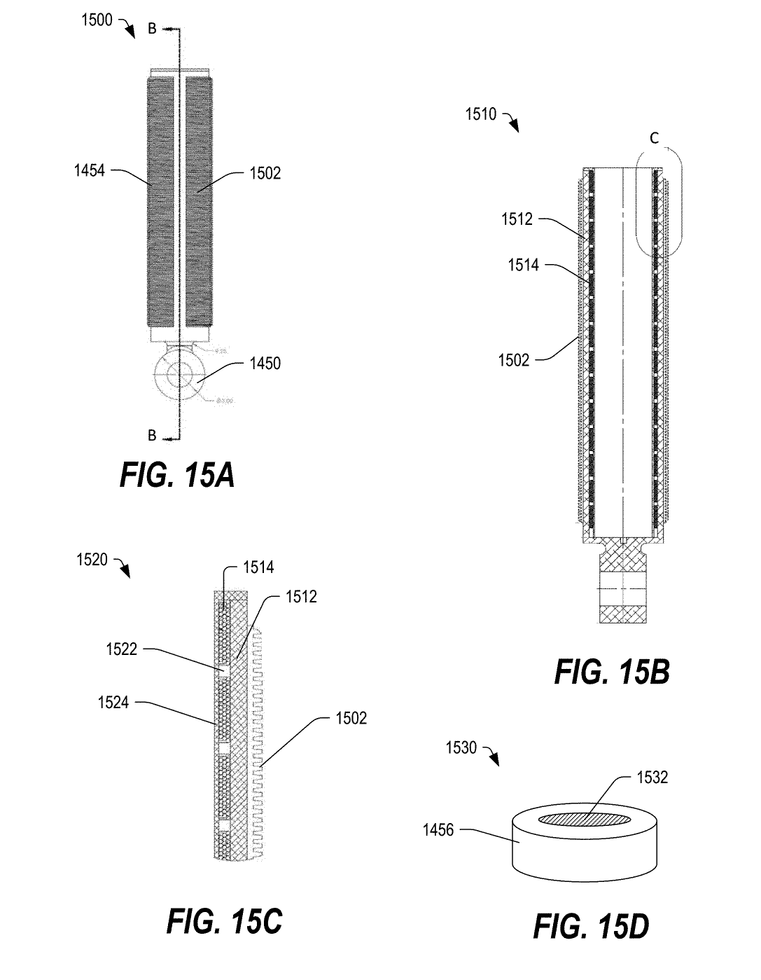

FIGS. 15A-15C depict views of a linear actuator portion of the apparatus of FIG. 14, in accordance with certain embodiments of the present disclosure. In FIG. 15A, the linear actuator 1454 includes a stator with a plurality of threads 1502 on an exterior surface to engage corresponding teeth or threads on an interior surface of a drive element 1456.

FIG. 15B depicts a cross-sectional view 1510 of the integrated linear damping stator (the linear actuator 1454) taken along line B-B in FIG. 15A. The stator 1454 can include a housing including an exterior surface having threads 1502 configured to engage corresponding threads of the drive element 1456. Further, the stator 1454 can include an insulative layer 1514 between the exterior surface including the threads 1502 and a plurality of electrical coils 1512.

FIG. 15C depicts a cross-sectional view 1520 of a portion of the integrated linear damping stator 1454 taken along line C-C in FIG. 15B. The stator coils 1512 may be separated or segmented by an air gap 1522. It should be appreciated that the implementation depicted in FIGS. 15A-15C represents one possible example of a housing for the stator 1454. Other embodiments are also possible.

FIG. 15D depicts a perspective view 1530 of a drive element 1456 of the apparatus of FIG. 14, in accordance with certain embodiments of the present disclosure. The drive element 1456 may include a central opening sized to fit over the linear actuator or stator 1454 and including threads 1532 configured to mate with threads 1502 on an exterior surface of the linear actuator or stator 1454.

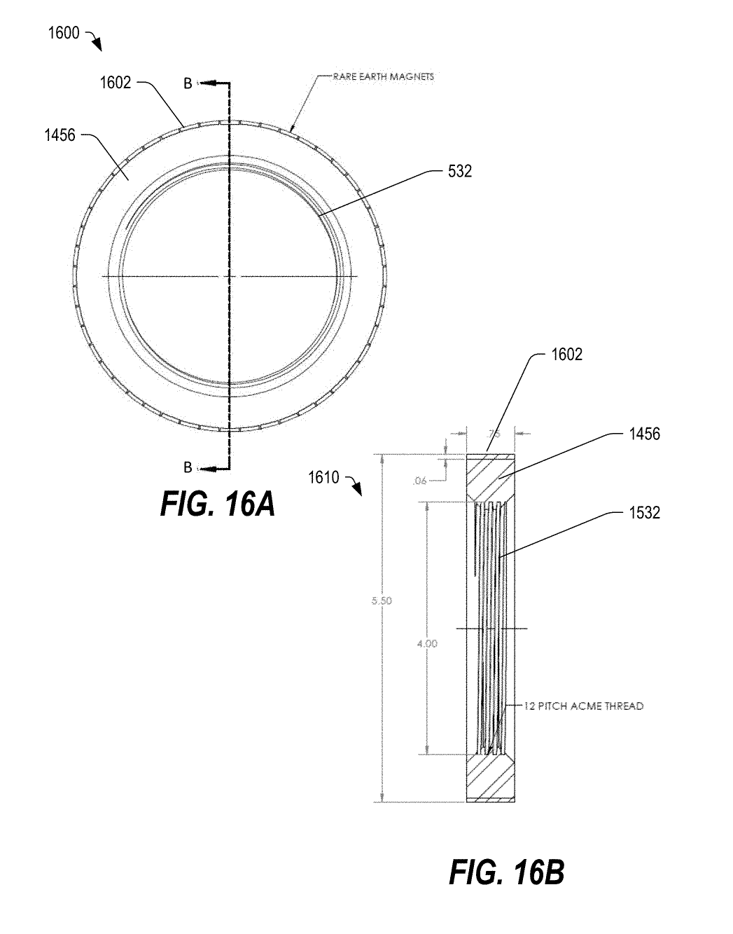

FIGS. 16A and 16B depict views of the drive element portion of the apparatus of FIGS. 14 and 15D, in accordance with certain embodiments of the present disclosure. FIG. 16A depicts a top view 1600 of a drive element 1456 of an active coil assembly 404, in accordance with certain embodiments of the present disclosure. The drive element 1456 includes a circumferential ring of rare earth magnets 1602, which may respond to an electrical field in the coils of the linear actuator or stator 1454 in FIG. 15A. Further, the drive element 1456 includes threads 1532 configured to mate with corresponding threads 1502 (FIGS. 15A-15C) on an exterior surface of the linear actuator or stator 1454.

FIG. 16B depicts a cross-sectional view of the drive element 1456 taken along line B-B in FIG. 16A, in accordance with certain embodiments of the present disclosure. In this example, the threads 1532 on an interior surface of the drive element 1456 may be configured to engage corresponding threads of the linear actuator or stator 1454. The threads 1532 may include a 12 pitch thread. Other thread configurations are also possible.

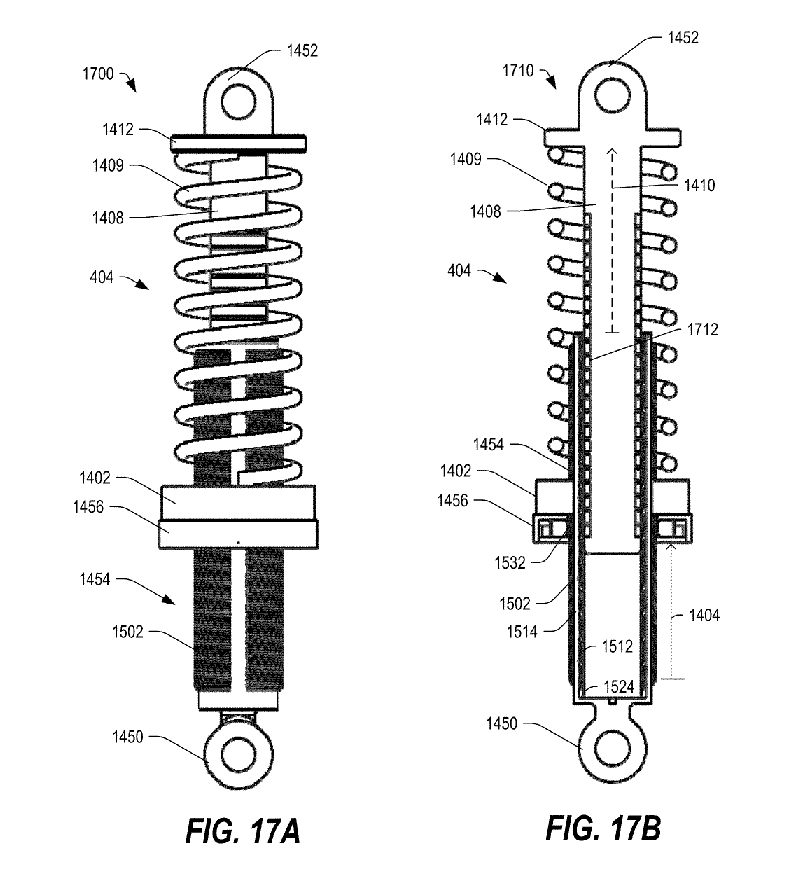

FIG. 17A depicts a side view 1700 of the active coil assembly 404 of FIG. 4, in accordance with certain embodiments of the present disclosure. The linear actuator or stator 1454 may be configured to drive the piston 1408 to extend or retract. Further, the linear actuator or stator 1454 may cause the drive element 1456 to advance by rotating and advancing along the threads 1502). By selectively controlling one or both of the piston 1408 and the drive element 1456, the compression on the spring 1409 can be adjusted.

FIG. 17B depicts a side cross-sectional view 1710 of the apparatus of FIG. 17A. The linear actuator 1454 includes a plurality of electric coils 1512, which may interact with permanent magnets 1712 within the piston 1408 to extend or retract the piston 1408. Further, the linear actuator 1454 may induce electrical fields that can interact with the permanent magnets of the drive element 1456 to turn the drive element 1456, advancing the coil stop 1402 to a selected position along the length of the linear actuator 1454 as indicated by arrow 1404.

In operation, the plunger or piston 1408 may be extended and the drive element 1456 lowered to reduce the compression on the spring or coil 1409 and increasing the stroke of the compression. The plunger or piston 1408 may be retracted, the drive element 1456 may be raised, or both, to increase the compression on the coil or spring 1409. In each instance, the linear actuator or stator 1454 may be responsive to control signals from a circuit to provide an active suspension. Other embodiments are also possible. It should be understood that the plunger or piston 1408 may extend from a first position to a second position, which may introduce a range of lengths for the linear actuator, providing a desired compression for the spring or coil 1409.

In conjunction with the systems, methods, devices, and components described above with respect to FIGS. 1-17B, an integrated wheel assembly is described that includes a first electric motor configured to rotate a tire about an axis defined by an orbital stator and a wheel hub. Further, the integrated wheel assembly includes a second motor configured to turn the wheel relative to a pivot axis to selectively alter a direction of travel of the rotating tire. Further, the integrated wheel assembly may include a third motor configured to selectively adjust a camber of the tire. Additionally, the integrated wheel assembly may include a fourth motor associated with an active coil assembly to selectively adjust a suspension of the vehicle.

In some embodiments, each integrated wheel assembly may include a wheel hub having a first circumferential arrangement of magnets configured to turn about an outside of an orbital stator coil and a second circumferential arrangement of magnets configured to turn about an inside of the orbital stator coil. The wheel hub may be coupled to a rim of a tire to exert a turning force on the tire in response to current flowing through the coils of the orbital stator coil. Additionally, the wheel hub may define an enclosure sized to receive one or more super capacitors, which may be configured to receive energy from the stator coils and to return energy to the stator coils. Further, the one or more super capacitors may store regenerative energy derived from braking and other sources of energy recapture.

In some embodiments, the active camber adjustment mechanism may be configured to dynamically adjust a camber of each tire independently to maintain a desired contact between the tire and the road surface. The active suspension may be configured to dynamically adjust the suspension of the vehicle, raise or lower tires, raise or lower the support structure of the vehicle and so on.

In some embodiments, the integrated wheel module takes advantage of the maximum space inside a truck wheel hub without any reduction gears so that it is able to drive forward and provide braking at the 0 to several 100 rpm range of speed that is sufficient to power a truck around town and at highway speeds. The integrated electrical motor is of sufficient power to enable full braking, which allows for power levels of up to approximately 1000 horsepower per wheel for a loaded truck. The elimination of reduction gears saves weight, reduces cost, increases reliability, and allows for the wheel motor to be of a size that really fits inside the truck wheel hub.

Further, the motor within the integrated wheel module can be designed in conjunction with the power electronics to greatly simplify delivery of power to the wheel as well as distribution of power inside the motor. The power electronics and the coils can be designed and constructed with integrated cooling so that a desired power densities and efficiencies can be achieved. Further, the heat that is generated by the minor residual inefficiencies can be overcome through the integrated cooling, which reduces the need for active cooling and which greatly extends the life and the reliability of the wheel unit. Further, by including integrated cooling fins in the assembly, the integrated cooling features also vastly reduce the number of mechanical parts that are required as compared to other vehicles and other designs. More importantly, the reduced number of mechanical parts enhances reliability and durability of the integrated wheel module, because the module includes fewer parts that might break down.

Integration of power storage units, such as super capacitors, can enable high speed switching between various coils and segments of the magnetics. Further, such power storage units may provide local storage of energy, which can minimize current peaks and transients between the external power source and each electrically driven wheel.

In some embodiments, the integrated wheel module may include an advanced magnetics design, which can take advantage of permanent (rare earth) magnets and which can manage the flux geometry in segmented magnet arrays in order to maximize the power densities and efficiencies. Further, the advanced, segmented magnet arrays eliminate problems associated with cogging and enhance switching speeds.

In some embodiments, a plurality of plates can be used for both power distribution and control communications between the various components. These plates may constitute the backbone of the power distribution within the integrated wheel module, greatly reducing the resistivity, eliminating a significant amount of the mechanical assembly labor, and enabling the phasing that may be necessary for different speed ranges with essentially the same motor geometry. This versatility allows the same motor design to be used at ranges from 0 to several 100 rpm in both directions. With some changes to the motor plates and the drive software for the power electronics, the integrated wheel module could also accommodate higher speed ranges up to and including turbines used for power generation.

Further, a number of safety considerations are built into the design of the electronics. For example, parallel-series redundancy allows for components to fail, including short circuit failures, while allowing the motor continue to operate. Moreover, the parallel-series redundancies ensure sufficient independent redundancy such that any subsystems failure does not completely disable the integrated wheel module. In some embodiments, there may also be short circuit detection variations that can rapidly shut off the power so that there is no arcing or meltdown or runaway operation that might otherwise result from any kind of failure or mechanical intrusion of water or objects.

In some embodiments, the power electronics and the advanced magnetics design for the rotary motor can also be applied to a series of linear actuators, which can be part of the active suspension and other applications that require linear actuators in a completely integrated electric vehicle, which may incorporate payload and other functions. In some embodiments, the power distribution system in the vehicle may include power rails on both sides of the vehicle, which may be coupled to each of the wheels along the vehicle and which may conduct power between battery banks. In some embodiments, both the power distribution system and each of the integrated wheel modules may include switching power electronics.

In some embodiments, any wheel of a vehicle may be replaced with an integrated wheel module. In the context of long-haul trucking (as opposed to a car implementation), some or all of the wheels of the truck and of the trailer may be integrated wheel modules. In an example, each wheel module (or each pair of wheel modules) could have independent power systems with batteries that are essentially located between the wheels. By locating the battery and charging, switching electronics, and the wheels on redundant direct current (DC) power buses, such an arrangement could provide inherent redundancy that allows the vehicle to operate independently and even to have reserve capacity in case the batteries become low, and the truck needs to limp home.

Additionally, the active suspension provides additional advantages. For example, if a tire has a failure or a flat, the active suspension can lift the tire off of the ground and the vehicle can continue to operate. The active suspensions of other wheel modules can be adjusted to keep the vehicle level and the vehicle can continue on without having to stop to change tires.

In the above-described implementations, the motor is integrated in a wheel, and the motor is designed such that the outside portion of the motor rotates. In other variants of these rotating electronics, the motor can be modified such that the inside of the motor rotates. It looks more like a conventional motor with a shaft that is rotating. These permanent magnet motors with similar, possibly smaller power electronic circuitry, then drive features like the steering function that is integrated into this wheel as well as the active camber feature that is integrated into this wheel. Further, these electronics and associated power electronics can be used to drive the active suspension units which are linear actuators, which may be one or likely two on each wheel and suspension unit.

Although the present invention has been described with reference to preferred embodiments, workers skilled in the art will recognize that changes may be made in form and detail without departing from the scope of the invention.

What is claimed is:

1. An integrated wheel module comprising:
a spindle assembly configured to couple to a wheel;
an orbital stator coil coupled to the spindle; and
a wheel hub including a mounting surface configured to couple to a rim of a wheel and including an opening configured to receive a portion of the spindle assembly, the wheel hub including a race configured to couple to an end of the spindle assembly, the wheel hub defining an enclosure sized to receive the orbital stator coil, the wheel hub including a plurality of magnets arranged in a circumferential configuration within the enclosure and configured to turn the wheel hub about an axis defined by the spindle in response to electrical current within the orbital stator coil.

2. The integrated wheel module of claim 1, wherein the plurality of magnets comprises:
a first plurality of magnets arranged in a circumferential configuration about an outside of the orbital stator coil within the enclosure; and
a second plurality of magnets arranged in a circumferential configuration about an inside of the orbital stator coil within the enclosure.

3. The integrated wheel module of claim 1, further comprising:
a steering knuckle coupled to the spindle assembly and including a hinge opening;
a camber housing including a corresponding opening aligned with the hinge opening; and
a king pin extending through the hinge opening and the corresponding opening;
wherein the steering knuckle is configured to pivot about the king pin to turn the spindle assembly and the wheel relative to the camber housing.

4. The integrated wheel module of claim 3, further comprising one or more motors coupled to the king pin and responsive to a control signal to turn the steering knuckle about the king pin.

5. The integrated wheel module of claim 1, further comprising:
a camber housing including a guide element;
an articulated camber slide coupled to the camber housing and configured to move along the guide element;
a first support arm including a first end coupled to a lower surface of the steering knuckle at a first pivot point and including a second end coupled to a first portion of a support structure of a vehicle at a second pivot point; and
a second support arm including a first end coupled to the articulated camber slide at a first pivot point and including a second end coupled to a second portion of the support structure of the vehicle at a second pivot point.

6. The integrated wheel module of claim 1, further comprising an active suspension including:
a linear dampening motor including a first end coupled to a lower mounting structure and including a second end coupled to a frame of a vehicle; and
a coil extending over the linear dampening motor between the second end of the linear dampening motor and a coil seat coupled to the linear dampening motor.

7. The integrated wheel module of claim 6, wherein the coil seat is adjustable along a length of the linear damping motor to define an adjustable coil stop.

8. A system comprising:
a plurality of integrated wheel modules, each integrated wheel module coupled to a rim of a tire and including:
control electronics;
one or more batteries;
a first motor responsive to the control electronics and configured to rotate the tire about an axis;
a second motor responsive to the control electronics to turn the tire about a pivot point;
a third motor responsive to the control electronics and configured to alter a camber angle of the tire;
a fourth motor responsive to the control electronics and configured to adjust a suspension assembly of the wheel module; and
a fifth motor configured to selectively adjust a compression of a spring of the suspension in accordance with a load.

9. The system of claim 8, further comprising a control system configured to communicate with the control electronics of each of the plurality of integrated wheel modules.

10. The system of claim 8, wherein the first motor comprises:
a stator assembly including a plurality of coils;
a rotor assembly including an inner magnetic array and an outer magnetic array, the inner and outer magnetic arrays formed from a plurality of magnets; and
a plurality of power electronics circuits, each power electronics circuit coupled to one of the plurality of coils and configured to control current flow into and out of the coil.

11. The system of claim 8, further comprising:
a camber housing coupled to a frame of a vehicle and including a first hinge opening;
a steering knuckle coupled to the rim of the tire, the steering knuckle including a second hinge opening corresponding to the first hinge opening of the camber housing;
a king pin configured to couple the camber housing to the steering knuckle via the first and second hinge openings; and
a motor configured to apply torque to the king pin to turn the steering knuckle to turn the tire relative to the pivot point defined by the king pin.

12. The system of claim 8, further comprising:
a camber housing defining an opening sized to receive at least a portion of the third motor, the camber housing including a guide element and including an attachment element, the camber housing coupled to a steering knuckle that is coupled to the rim of the tire;
a slider configured to engage the guide element and to move back and forth along the guide element, the slider including a slider attachment;
an upper mounting frame including a frame attachment element coupled to a frame of a vehicle and including a slider attachment element configured to couple to the slider attachment;
a lower mounting frame including a frame attachment element coupled to the frame of the vehicle and including a camber housing attachment element configured to couple to the attachment element of the camber housing; and
wherein the third motor is configured to selectively move one of the camber housing and the slider to adjust a camber angle of the tire relative to the frame of the vehicle.

13. The system of claim 8, further comprising the suspension assembly including:
the third motor including a linear actuator having a housing with a plurality of threads and including a piston configured to move relative to the linear actuator, the piston including a proximal end including a plurality of magnets and a distal end including a frame attachment element and a first coil stop;
a second coil stop including a plurality of threads configured to engage the plurality of threads of the housing; and
a coil extending over the linear motor between the first coil stop and the second coil stop.

14. The system of claim 13, wherein the third motor is configured to adjust a position of the second coil stop along a length of the housing to adjust a neutral compression of the suspension assembly.

15. The system of claim 13, wherein the third motor is configured to control the linear actuator to lift the tire off of the ground.

16. A system comprising:
a plurality of integrated wheel modules, each integrated wheel module including:
a motor configured to rotate a tire of the wheel module independent of other tires of the plurality of integrated wheel modules;
an active steering component configured to steer the tire relative to a pivot point independent of other tires of the plurality of integrated wheel modules;
an active suspension configured to dynamically and continuously adjust a spring compression and a compression stroke independent of other tires of the plurality of integrated wheel modules; and
a camber adjustment element configured to dynamically and continuously adjust a camber angle of the tire independent of other tires of the plurality of integrated wheel modules.

17. The system of claim 16, wherein each integrated wheel module further comprises power electronics configured to control acceleration, steering, suspension adjustments, and camber adjustments.

18. The system of claim 16, wherein the active suspension comprises:
a compressible coil;
a linear motor sized to fit within the compressible coil and including a housing having a plurality of threads, the linear motor including an actuator and a piston, the piston including a frame attachment element and a first coil stop; and
a second coil stop configured to engage the plurality of threads of the housing of the linear motor and dynamically adjustable to provide a neutral spring compression.

19. The system of claim 16, wherein the motor comprises:
a rotary stator assembly including a plurality of coils; and
a rotor assembly including an inner magnet array and an outer magnet array defining a channel sized to fit the plurality of coils; and
power electronics associated with each coil of the plurality of coils.

20. The system of claim 19, wherein the power electronics include at least one of a snubber circuit and a capacitor configured to store power from the coil and to return power to the coil in response to switching operations.
